(19) United States
(12) Patent Application Publication
(10) Pub. No.: US 2010/0182343 A1
(43) Pub. Date: Jul. 22, 2010

(54) DISPLAY CONTROL DEVICE AND IMAGING DEVICE

(75) Inventor: Naoto YUMIKI, Osaka (JP)

Correspondence Address: Shinjyu Global IP, 1-4-9 Minamimori-machi, Kita-ku, South Forest Building, 11th Floor, Osaka, 530-0054, JP

(73) Assignee: Panasonic Corporation, Osaka (JP)

(21) Appl. No.: 12/687,132

(22) Filed: Jan. 14, 2010

(30) Foreign Application Priority Data
Jan. 16, 2009 (JP) 2009-007302

(51) Int. Cl. G09G 5/00

(52) U.S. Cl. 345/661; 345/676; 345/156

(57) ABSTRACT

The display control device disclosed herein includes an acquisition section, a display method determination section, and an image display controller. The acquisition section is configured to acquire from a recording part an image and movement information related to at least one of the movement of a housing and the movement of a subject within the image. The display method determination section is configured to determine the display method of the image on the display unit on the basis of the movement information. The image display controller is configured to display the image on the display unit so that the image moves on the screen of the display unit, on the basis of the determination result of the display method determination section.

### CROSS-REFERENCE TO RELATED APPLICATIONS

This application claims priority to Japanese Patent Application No. 2009-007302 filed on Jan. 16, 2009. The entire disclosure of Japanese Patent Application No. 2009-007302 is hereby incorporated herein by reference.

### BACKGROUND

1. Technical Field

The technology disclosed herein relates to a display control device, and more particularly to a display control device with which a plurality of images can be displayed as a slideshow.

2. Background Information

Recent years have witnessed an increase in the degree of integration in signal processing and image sensors such as a CCD (charge coupled device) and a CMOS (complementary metal-oxide semiconductor), and prices have fallen. Therefore, imaging devices with which an optical image of a subject can be converted into an electrical image signal and outputted have surged in popularity. Examples of imaging devices include digital still cameras and digital video cameras (hereinafter referred to simply as digital cameras). In particular, most imaging devices today combine the functions of both still and moving picture photography.

Also, most digital cameras are equipped with a compact display device, and have the function of displaying images one at a time, or the function of displaying a plurality of images as a list (hereinafter referred to as thumbnail display). A method in which images are displayed according to the orientation of the digital camera during photography has been proposed, for example, as a more convenient display method (see, for example, Japanese Laid-Open Patent Application 2001-45354).

A display device may also have a function of displaying images as a slideshow (see, for example, Japanese Laid-Open Patent Application 2006-54525). In Japanese Laid-Open Patent Application 2006-54525 there is proposed a slideshow display function with which reproduced images are displayed so that an entire vista or landscape can be viewed by panning, movement from top to bottom (such as a setting sun), or movement from bottom to top (such as fireworks), is expressed by tilting, and reproduced images are enlarged so that the focus is on the main subject by zooming in.

When a moving subject (such as a car or airplane) is photographed, the user captures the image while moving the digital camera horizontally, vertically, or diagonally. Thus changing the direction in which the digital camera faces is called panning. When a plurality of still pictures sequentially captured by panning (hereinafter referred to as panned images) are displayed as thumbnails, in the past they were displayed side by side in the order of the date and time when they were captured.

However, with a conventional slideshow display such as this, since reproduced images matching the movement of the subject are displayed on the basis of photography information determined by the user at the time of capture, images matching the movement of the subject at the time of capture cannot be automatically displayed. Accordingly, the images displayed as a slideshow may appear strange to the user.

### SUMMARY

The display control device disclosed herein is a device for displaying on a display unit an image recorded to a recording part, comprising an acquisition section, a display method determination section, and an image display controller. The acquisition section is configured to acquire from the recording part an image and movement information related to at least one of the movement of a housing and the movement of a subject within the image. The display method determination section is configured to determine the display method of the image on the display unit on the basis of the movement information. The image display controller is configured to display the image on the display unit so that the image moves on the screen of the display unit, on the basis of the determination result of the display method determination section.

The imaging device disclosed herein comprises a housing, an optical system, an image acquisition section, a display unit, a movement detector, a display method determination section, and an image display controller. The optical system is supported by the housing and configured to form an optical image of a subject. The image acquisition section is configured to convert the optical image formed by the optical system into an electrical image signal, and is configured to acquire an image of the subject. The display unit is configured to display images acquired by the image acquisition section. The movement detector is configured to acquire movement information relate to at least one of the movement of the imaging device and the movement of the subject within the image. The display method determination section is configured to determine the display method of the image on the display unit on the basis of the movement information. The image display controller is configured to display the image on the display unit so that the image moves on the screen of the display unit, on the basis of the determination result of the display method determination section.

### BRIEF DESCRIPTION OF THE DRAWINGS

Referring now to the attached drawings, which form a part of this original disclosure:

FIG. 1 is a block diagram of a control system for a digital camera;

FIG. 2A is a top view of a digital camera, and FIG. 2B is a rear view of a digital camera;

FIG. 3 is a diagram of the hardware configuration of a shake correction device;

FIG. 4 is an exploded oblique view of a shake correction device;

FIG. 5 is a table showing panning mode signals;

FIGS. 6A and 6B are diagrams of the orientation of the shake correction device;

FIG. 7 is a graph of the coil supply current for each photography orientation;

FIG. 8 is a table of orientation identification signals;

FIG. 9 is a diagram illustrating the file management method for captured images;

FIG. 10 is a diagram illustrating the file management method for sequentially captured images;

FIG. 11 is a diagram illustrating a panning photography state;

FIG. 12 is a flowchart of a photography method;

FIG. 13 is a flowchart illustrating the display method with a slideshow;

FIG. 14 is a flowchart illustrating the display method with a slideshow;

FIG. 15 is a flowchart illustrating the display method with a slideshow;

FIG. 16 is a flowchart illustrating the display method with a slideshow;

FIG. 17 is a flowchart illustrating the display method with a slideshow;

FIG. 18 is an example of a thumbnail display of a sequentially captured image folder;

FIG. 19 is an example of thumbnail displays of sequentially captured images;

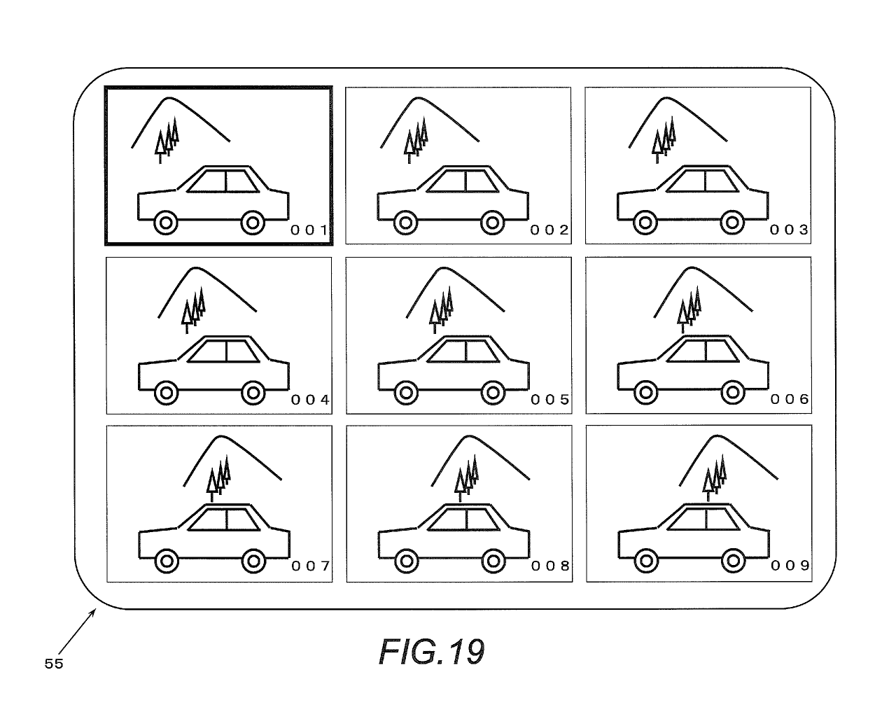

FIGS. 20A to 20C are examples of a slideshow display (sequentially captured image folder #1);

FIGS. 21A to 21C are examples of a slideshow display (sequentially captured image folder #2);

FIGS. 22A to 22C are examples of a slideshow display (sequentially captured image folder #3);

FIGS. 23A to 23C are examples of a slideshow display (sequentially captured image folder #4);

FIG. 24 is a diagram illustrating a panning photography state (second embodiment);

FIG. 25 is a diagram of the hardware configuration of a movement vector detector (second embodiment);

FIG. 26 is a diagram of a digital camera and a display device (second embodiment);

FIG. 27 is examples of devices in which a display control device is installed (fourth embodiment);

FIGS. 28A to 28C are examples of a slideshow display (other embodiment); and

FIGS. 29A to 29C are examples of a slideshow display (other embodiment).

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

### Overall Configuration of Digital Camera

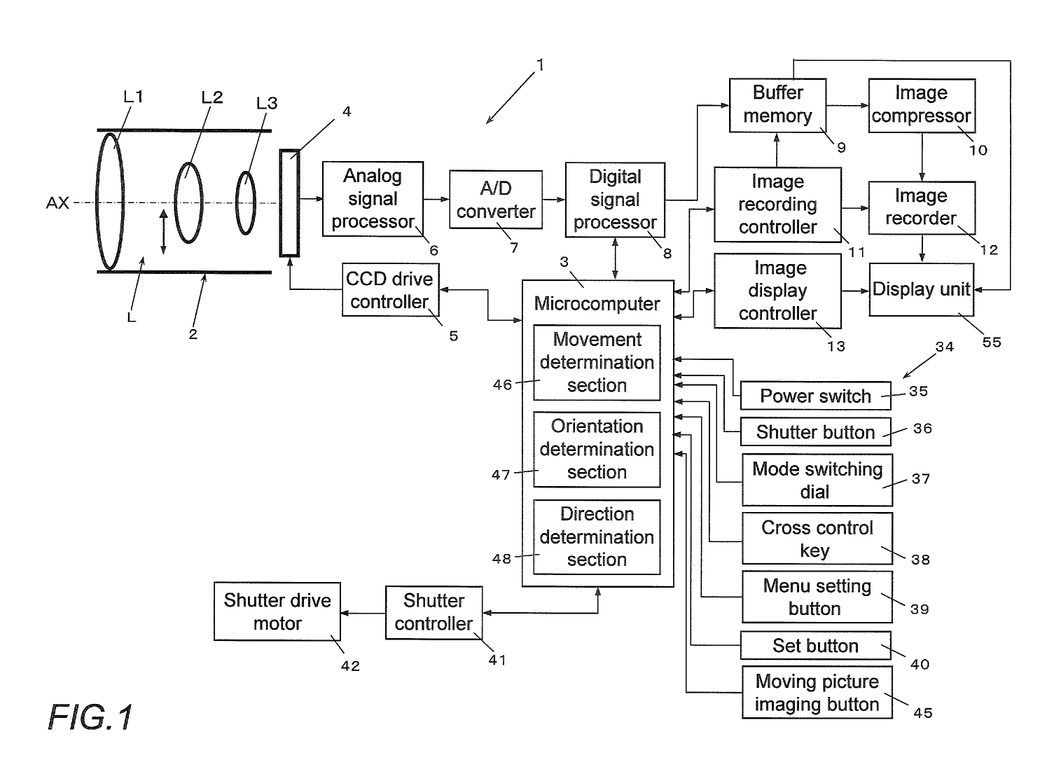

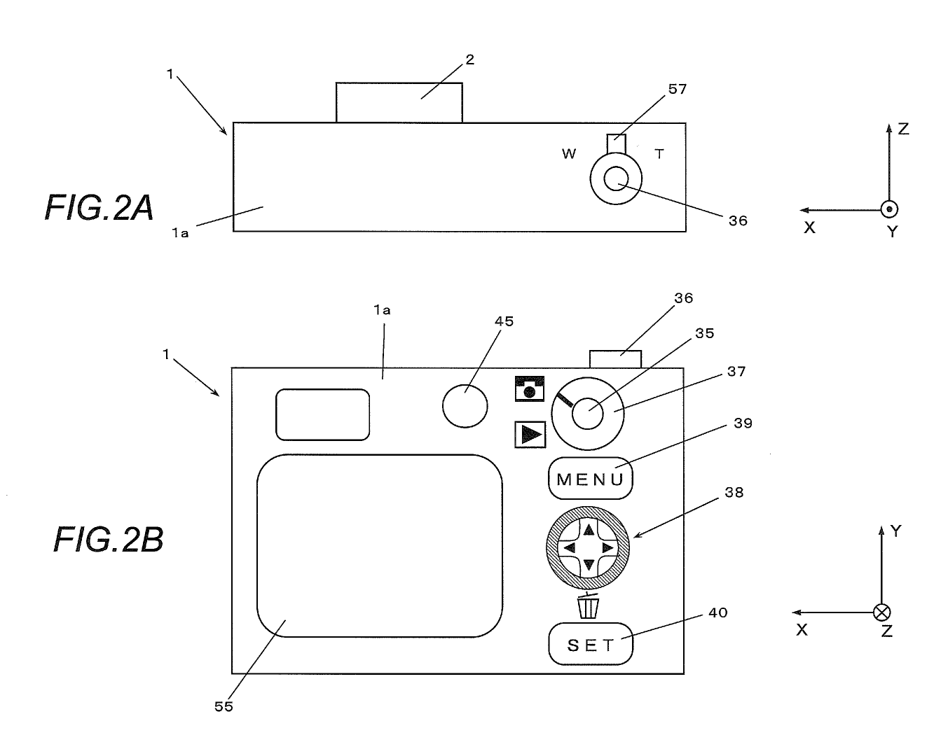

The digital camera 1 according to the first embodiment will be described through reference to FIGS. 1 and 2. FIG. 1 is a block diagram of the simplified configuration of the digital camera 1. FIG. 2A is a top view of the digital camera 1, and FIG. 2B is a rear view of the digital camera 1. As shown in FIG. 2, we will let the Z axis direction be the direction along the optical axis AX of the digital camera 1, the X axis direction the left and right direction of the digital camera 1, and the Y axis direction the up and down direction of the digital camera 1. These directions do not limit how the digital camera 1 is used.

As shown in FIG. 1, the digital camera 1 (an example of an imaging device) has an optical system L, a microcomputer 3, an image sensor 4 (an example of an image acquisition section), a CCD drive controller 5, a shutter controller 41, and a shutter drive motor 42.

The optical system L is an optical system for forming an optical image of a subject, and includes three lens groups L1, L2, and L3. The optical system L is supported by a lens barrel 2. The first lens group L1 is a lens group for performing focussing, and is provided to be movable along the optical axis AX. The third lens group L3 is a lens group for performing zooming, and is provided to be movable along the optical axis AX. The second lens group L2 is a lens group for correcting blurring of the image caused by movement of the digital camera 1, and is provided to be movable in a plane perpendicular to the optical axis AX. Blurring of the image can be corrected by using the second lens group L2 to make the optical axis AX eccentric. The second lens group L2 is included in a blur correction device 20 (discussed below).

The microcomputer 3 is a unit for controlling the entire digital camera 1, and is connected to various units. More specifically, the microcomputer 3 has a movement determination section 46 (an example of a first information generator), an orientation determination section 47, and a direction determination section (an example of a display direction determination section). The functions of the various components are carried out by programs. The microcomputer 3 also has a function of reading images recorded to an image recorder 12, via an image recording controller 11. That is, the microcomputer 3 can function as an acquisition section for temporarily acquiring images recorded to the image recorder 12.

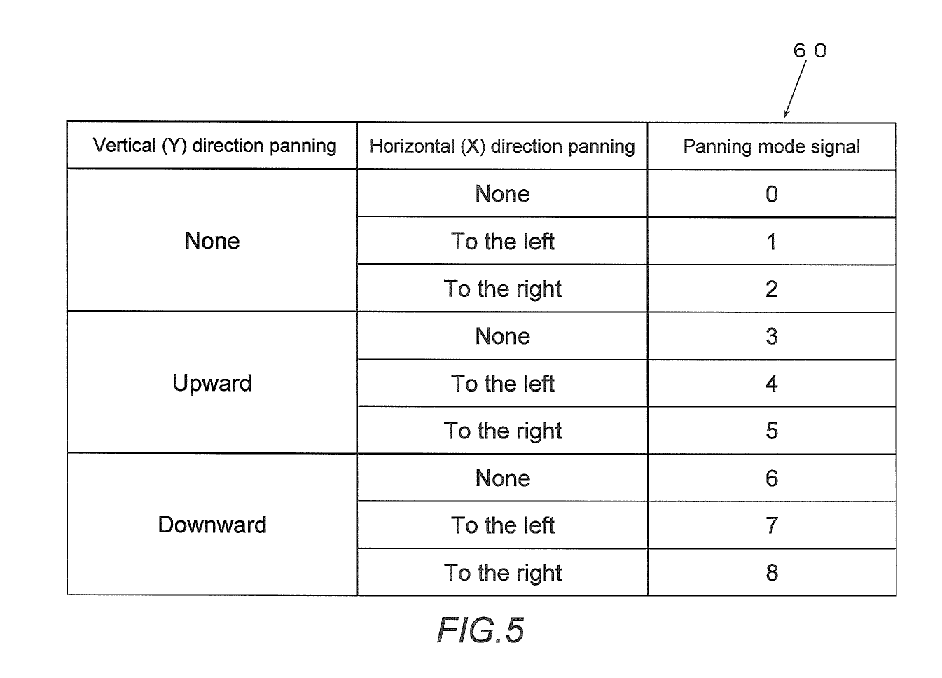

The movement determination section 46 determines the direction of panning and generates a panning mode signal 60 (an example of first movement information) by utilizing the output of a movement detector 17A (more precisely, angular velocity sensors 17x and 17y (discussed below)). The panning mode signal 60 indicates the direction in which the digital camera 1 has moved, and is used to determine the movement direction of an image in a slideshow display. The table of panning mode signals 60 shown in FIG. 5 is held, for example, in an internal memory (not shown) of the microcomputer 3. Therefore, the vertical and horizontal directions indicated by the panning signal can be determined by comparing the generated panning signal to the table show in FIG. 5.

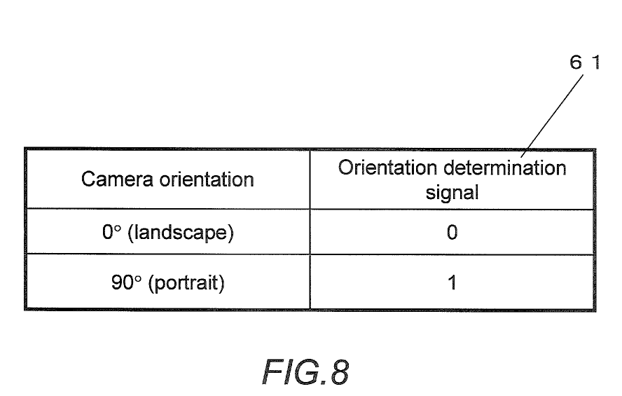

The orientation determination section 47 generates an orientation determination signal 61 (an example of orientation information) by utilizing the output of a yaw current value detector 14x and a pitch current value detector 14y (discussed below). The orientation determination signal 61 indicates the orientation of the digital camera 1 with respect to the vertical direction. Whether the digital camera 1 is in landscape or portrait orientation can be determined on the basis of the orientation determination signal 61. The table of orientation determination signals 61 shown in FIG. 8 is held, for example, in an internal memory (not shown) of the microcomputer 3. Therefore, the imaging orientation of the digital camera 1 indicated by the orientation determination signal can be determined by comparing the generated orientation determination signal to the table show in FIG. 8.

A direction determination section 48 determines the movement direction of an image in a slideshow display on the basis of the detection result of the movement determination section 46. More specifically, the movement determination section 46 determines the movement direction of an image on a display unit 55 on the basis of the panning mode signal 60 stored in the image recorder 12 along with an image. For example, if imaging is performed while the digital camera 1 is panned to the left, the direction determination section 48 generates a control signal indicating movement to the left on the screen of the display unit 55, and sends this signal to an image display controller 13. If imaging is performed while the digital camera 1 is panned to the right, the direction determination section 48 generates a control signal indicating movement to the right on the screen of the display unit 55, and sends this signal to an image display controller 13.

The shutter controller 41 drives the shutter drive motor 42 on the basis of a control signal from the microcomputer 3 in order to operate the shutter. This control signal is generated by the microcomputer 3 on the basis of a timing signal obtained by pressing a shutter button 36.

The image sensor 4 is a CCD, for example, and converts an optical image formed by the optical system L into an electrical image signal. Drive of the imaging sensor 4 is controlled by the CCD drive controller 5. The imaging sensor 4 may instead be a CMOS sensor.

As shown in FIG. 1, a control panel 34 is provided to the digital camera 1 in order to input control information from the outside. More specifically, the control panel 34 has a power switch 35, the shutter button 36, a mode switching dial 37, a cross control key 38, a menu setting button 39, and a set button 40. The microcomputer 3 is connected to the control panel 34, and is able to receive signals from the control panel 34.

As shown in FIGS. 2A and 2B, the optical system L and the lens barrel 2 are disposed on the front face of a housing 1a, and the power switch 35, the mode switching dial 37, the cross control key 38, the menu setting button 39, the set button 40, a moving picture imaging button 45, and the display unit 55 are disposed on the rear face. The shutter button 36 and a zoom control lever 57 are disposed on the top face of the housing 1a.

The zoom control lever 57 is provided around the shutter button 36 to be rotatable coaxially with the shutter button 36. The power switch 35 is used for switching the power on and off to the digital camera 1. The mode switching dial 37 is used for switching between still picture photography mode, moving picture photography mode, and reproduction mode. When the still picture photography mode is selected with the mode switching dial 37, the photography mode can be switched to still picture photography mode, and when the moving picture photography mode is selected with the mode switching dial 37, the photography mode can be switched to moving picture photography mode. In moving picture photography mode, basically moving picture photography is possible. When the reproduction mode is selected with the mode switching dial 37, the captured image can be displayed on the display unit 55. Also, if the zoom control lever 57 is rotated to the right in a state in which the photography mode has been switched to still picture photography mode or moving picture photography mode, the lens barrel 2 is driven to the telephoto side by a zoom motor (not shown), and when this lever is rotated to the left, the lens barrel 2 is driven to the wide angle side by the zoom motor. The operation of the zoom motor is controlled by the microcomputer 3.

The moving picture imaging button 45 is used to start and stop moving picture imaging, and regardless of whether the imaging mode set on the mode switching dial 37 is the still picture imaging mode or the moving picture imaging mode, when this moving picture imaging button 45 is pressed, the moving picture imaging mode is forcibly started, irrespective of the setting on the mode switching dial 37. Furthermore, when this moving picture imaging button 45 is pressed in moving picture imaging mode, moving picture imaging is stopped and the mode changes to still picture imaging mode or reproduction mode.

The menu setting button 39 is used to display various menus on the display unit 55. The cross control key 38 is a button with which the user presses the top, bottom, left, or right side and uses the menu setting button 39 to select the desired category or menu from among the various menus displayed on the display unit 55. The set button 40 is used to execute the options on the various menus.

As shown in FIG. 1, the digital camera 1 further has an analog signal processor 6, an A/D converter 7, a digital signal processor 8, a buffer memory 9, an image compressor 10, the image recording controller 11, the image recorder 12 (an example of a recording part), the image display controller 13, and the display unit 55.

The image signal outputted from the imaging sensor 4 is processed by the analog signal processor 6, the A/D converter 7, the digital signal processor 8, the buffer memory 9, and the image compressor 10, in that order. The analog signal processor 6 subjects the image signal outputted from the imaging sensor 4 to gamma processing or other such analog signal processing. The A/D converter 7 converts the analog signal outputted from the analog signal processor 6 into a digital signal. The digital signal processor 8 subjects the image signal that has been converted into a digital signal by the A/D converter 7 to noise elimination, contour enhancement, or other such digital signal processing. The buffer memory 9 is a random access memory (RAM), and temporarily stores the image signal processed by the digital signal processor 8.

The image signal recorded to the buffer memory 9 is further processed by the image compressor 10 and the image recorder 12, in that order. The image signal stored in the buffer memory 9 is sent to the image compressor 10 at the command of the image recording controller 11, and the data of the image signal is compressed. The image signal is compressed to a data size that is smaller than that of the original data. The compression method can be, for example, JPEG (Joint Photographic Experts Group). For a moving picture, MPEG (Moving Picture Experts Group) is used. At the same time, the image compressor 10 produces a reduced image signal corresponding to the image used for the thumbnail display, etc. After this, the compressed image signal and the reduced image signal are sent to the image recorder 12.

The image recorder 12 is constituted by an internal memory 50 (not shown) provided to the main part of the digital camera 1, a removable memory (not shown), or the like, and records an image signal (moving picture images and still picture images), a corresponding reduced image signal, and specific information on the basis of a command from the image recording controller 11, with these signals and information recorded such that they are associated with one another. Examples of the specific information recorded along with these image signals include the date and time an image was captured, focal length information, shutter speed information, aperture value information, and imaging mode information. Also, with this digital camera 1, orientation information and panning information about the digital camera 1 (discussed below) and movement information about the subject are included as specific information. More specifically, the panning mode signal 60 and the orientation determination signal 61 are stored along with an image in the image recorder 12.

The image display controller 13 is controlled by a control signal from the microcomputer 3. For example, the microcomputer 3 sends the image display controller 13 a control signal indicating the movement direction of the image determined by the direction determination section 48. On the basis of this control signal, the image display controller 13 controls the display unit 55, and the display unit 55 displays the image signal recorded to the image recorder 12 or the buffer memory 9 as a visible image. The display state of the display unit 55 may be a state in which just the image signal is displayed, or a state in which the above-mentioned specific information is displayed along with the image signal. The display of the specific information is switched by operation of the menu setting button 39, for example.

Configuration of Blur Correction Device

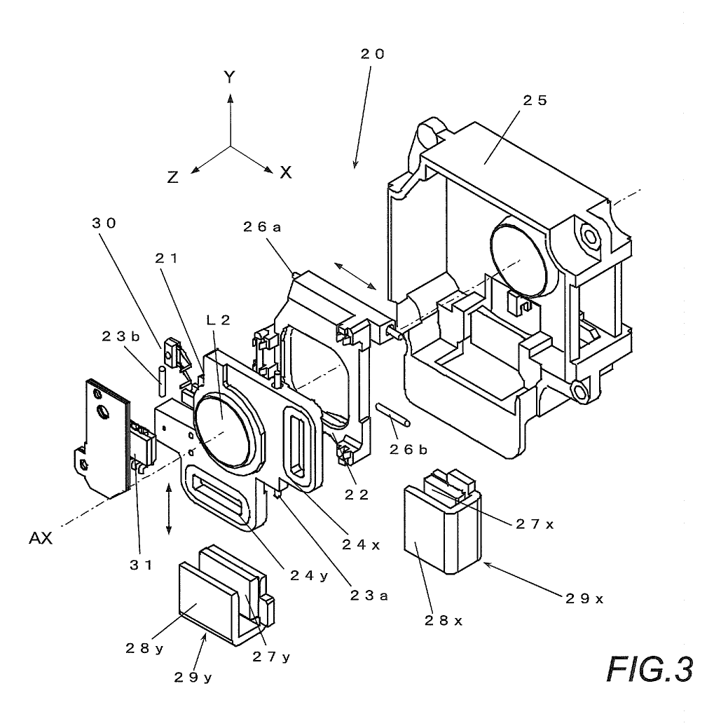

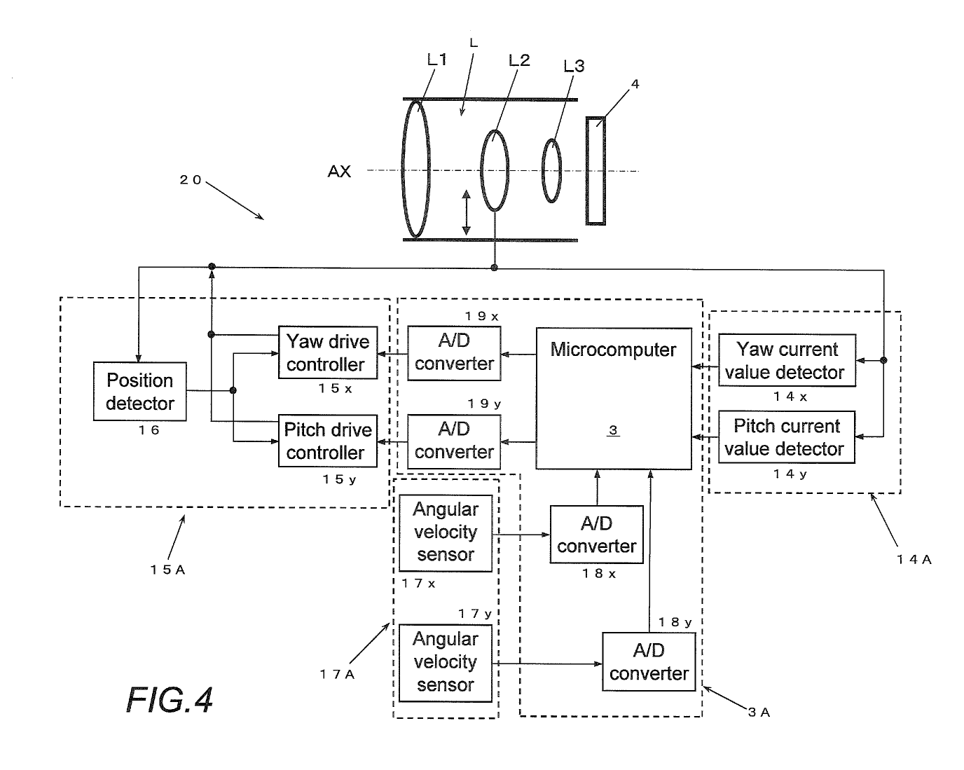

Next, the configuration of a blur correction device 20 will be described through reference to FIGS. 3 and 4. FIG. 3 is an exploded oblique view of the blur correction device 20.

When the digital camera 1 is subjected to mechanical vibration, shaking of the user's hands, etc., the optical axis of the light incident on the lens from the subject becomes misaligned with the optical axis AX of the lens, so the resulting image is not sharp. The blur correction device 20 is installed in the digital camera 1 to prevent this blurring of the image. More specifically, as shown in FIGS. 3 and 4, the blur correction device 20 has a pitch support frame 21, a yaw support frame 22, a fixing frame 25, a yaw actuator 29x, a pitch actuator 29y, a light emitting element 30, and a light receiving element 31.

Coils 24x and 24y are provided to the pitch support frame 21. The second lens group L2 and the light emitting element 30 are fixed to the pitch support frame 21. The pitch support frame 21 is supported by the yaw support frame 22 via two pitch shafts 23a and 23b to be relatively movable in the Y direction.

The yaw support frame 22 is supported by the fixing frame 25 via yaw shafts 26a and 26b to be relatively movable in the X direction. The yaw actuator 29x has a magnet 27x and a yoke 28x, and is supported on the fixing frame 25. The pitch actuator 29y has a magnetic 27y and a yoke 28y, and is supported on the fixing frame 25. The light receiving element 31 is fixed to the fixing frame 25, and receives light emitted from the light emitting element 30. The two-dimensional position coordinates of the second lens group L2 can be detected by the light emitting element 30 and the light receiving element 31.

As shown in FIG. 4, the blur correction device 20 further has a movement corrector 15A, an orientation detector 14A, a movement detector 17A (an example of a first movement detector), and a signal processor 3A that includes the microcomputer 3. The movement corrector 15A includes the second lens group L2, a yaw drive controller 15x, a pitch drive controller 15y, and a position detector 16. Drive of the second lens group L2 in two directions perpendicular to the optical axis AX (the X axis direction and the Y axis direction) is controlled by the yaw drive controller 15x and the pitch drive controller 15y. The X axis direction will hereinafter be referred to as the yaw direction, and the Y axis direction as the pitch direction. The position detector 16 is a unit for detecting the position of the second lens group L2 within the X-Y plane on the basis of the output from the light receiving element 31, and, along with the yaw drive controller 15x and the pitch drive controller 15y, forms a feedback control loop for controlling the operation of the second lens group L2.

The orientation detector 14A includes a yaw current value detector 14x and a pitch current value detector 14y. The yaw current value detector 14x detects the value of the current supplied to the coil 24x when the yaw actuator 29x operates (discussed below). The pitch current value detector 14y detects the value of the current supplied to the coil 24y when the pitch actuator 29y operates. The orientation of the digital camera 1 is determined by the orientation determination section 47 of the microcomputer 3 on the basis of the output of the yaw current value detector 14x and the pitch current value detector 14y. The orientation of the digital camera 1 can be detected with this constitution.

The movement detector 17A includes a yaw angular velocity sensor 17x (an example of a first detector) and a pitch angular velocity sensor 17y (an example of a second detector). The angular velocity sensors 17x and 17y are used for detecting movement of the digital camera 1 itself, including the imaging optical system L, produced by shaking of the user's hands and other such vibrations, etc., and detects movement in the yaw direction and pitch direction. More precisely, the yaw angular velocity sensor 17x is mainly used for detecting the angular velocity of the digital camera 1 around the Y axis. The pitch angular velocity sensor 17y is mainly used for detecting the angular velocity of the digital camera 1 around the X axis. The angular velocity sensors 17x and 17y use as a reference the output when the digital camera 1 is stationary, and output positive or negative angular velocity signals depending on the direction in which the digital camera 1 is moving. The outputted signals are processed by a signal processor 3A.

The signal processor 3A includes the microcomputer 3, A/D converters 18x and 18y, and A/D converters 19x and 19y. The signals outputted from the angular velocity sensors 17x and 17y undergo filtering, amplification, or other such processing, and are then converted into digital signals by the A/D converters 18x and 18y and outputted to the microcomputer 3. The microcomputer 3 subjects the output signals of the angular velocity sensors 17x and 17y, which have been taken in via the A/D converters 18x and 18y, to filtering, integration, phase compensation, gain adjustment, clipping, or other such processing. The result of performing this processing is that the microcomputer 3 computes the amount of drive control of the second lens group L2 needed for movement correction, and produces a control signal. The control signal thus produced is outputted through the A/D converters 19x and 19y to the yaw drive controller 15x and the pitch drive controller 15y. As a result, the yaw drive controller 15x and the pitch drive controller 15y drive the second lens group L2 on the basis of the control signal, and the image blurring is corrected.

Panning Mode Signal

With this digital camera 1, the angular velocity sensors 17x and 17y can be utilized to acquire a panning mode signal 60 (an example of first movement information) related to the direction of panning, etc. More specifically, during panning, the angular velocities outputted from the angular velocity sensors 17x and 17y have the same sign, and a state continues in which the outputted angular velocities are at or above a specific level. This is utilized by the orientation determination section 47 of the microcomputer 3 to determine whether or not the angular velocity signals from the angular velocity sensors 17x and 17y are at or above a certain threshold continuously for a specific length of time, and the panning mode signal 60 shown in FIG. 5 is produced by the movement determination section 46 on the basis of this determination result.

For example, if the user pans to the right (facing the subject) during photography, the microcomputer 3 comes to the conclusion of “none” regarding panning in the vertical (Y axis) direction from the output signal of the pitch angular velocity sensor 17y. Meanwhile, the microcomputer 3 concludes from the output signal of the yaw angular velocity sensor 17x that panning in the horizontal (X axis) direction is “to the right.” Therefore, the panning mode signal 60 is “2.”

When the user pans upward and to the left (facing the subject), the microcomputer 3 concludes from the output signal of the pitch angular velocity sensor 17y that the panning in the vertical direction is “upward,” and concludes from the output signal of the yaw angular velocity sensor 17x that the panning in the horizontal direction is “to the left.” Therefore, the panning mode signal 60 is “4.”

Thus, movement of the digital camera 1 during photography can be ascertained by the yaw angular velocity sensor 17x and the pitch angular velocity sensor 17y. The panning mode signal 60 is utilized in deciding the layout of the images displayed on the display unit 55.

Orientation Determination Signal

Also, with this digital camera 1, in addition to the panning mode signal 60, the orientation determination section 47 uses the yaw current value detector 14x and the pitch current value detector 14y to find an orientation determination signal 61 in order to determine the orientation of the digital camera 1.

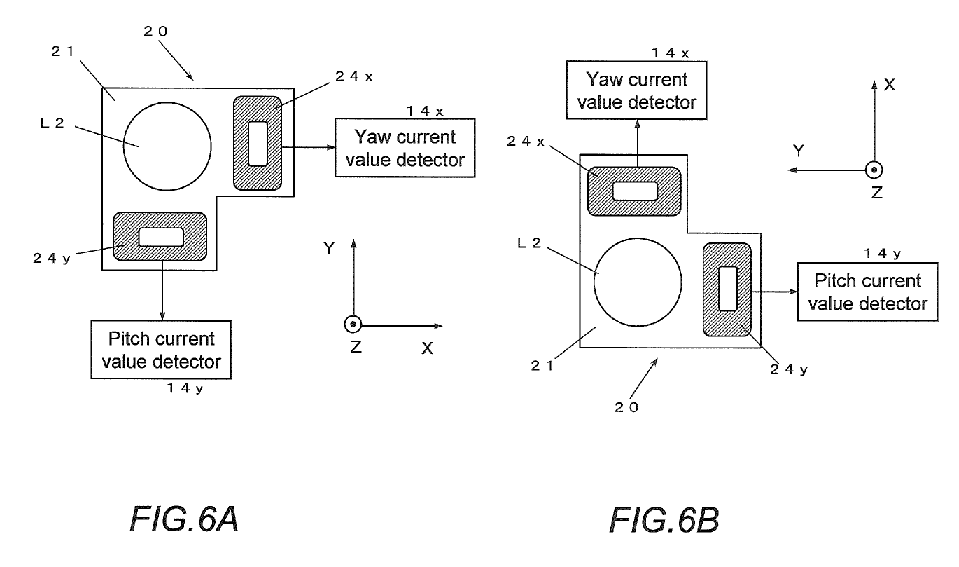

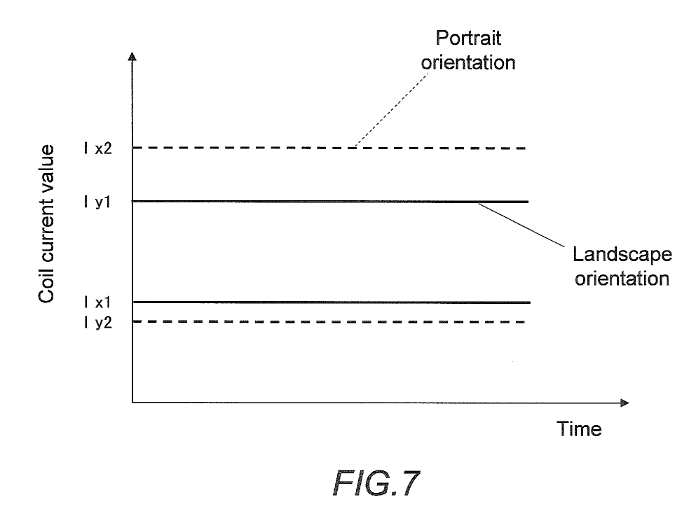

Next, the method for detecting the current value with the yaw current value detector 14x and the pitch current value detector 14y will be described through reference to FIGS. 6 and 7. FIG. 6A shows the orientation of the blur correction device 20 in photography with a landscape orientation, and FIG. 6B shows the orientation of the blur correction device 20 in photography with a portrait orientation. FIG. 7 is a graph of the coil supply current for each photography orientation. The term “landscape orientation” as used here means that the lengthwise direction of the display unit 55 (the lengthwise direction of the housing 1a) substantially coincides with the horizontal direction, and “portrait orientation” means that the lengthwise direction of the display unit 55 substantially coincides with the vertical direction.

As shown in FIG. 6A, in landscape orientation, since the pitch direction substantially coincides with the vertical direction, the pitch support frame 21 that supports the second lens group L2 wants to go down under its own weight in the Y axis direction. Since the second lens group L2 must be supported at a specific position (near the center of the optical axis AX, for example) in order to obtain a good image, current is supplied to the coil 24y, and the pitch actuator 29y generates electromagnetic force for supporting the pitch support frame 21 on the fixing frame 25. As shown in FIG. 7, the current value at this point is termed Iy1, for example.

Meanwhile, since the yaw direction substantially coincides with the horizontal direction, the yaw actuator 29x does not need to generate any extra electromagnetic force to support the weight of the yaw support frame 22 or the pitch support frame 21. Therefore, the current value Ix1 supplied to the coil 24x is smaller than the current value Iy1 supplied to the coil 24y. The microcomputer 3 has a function of comparing the current values detected by the current value detectors 14x and 14y, and a function of determining the orientation of the digital camera 1. Therefore, the current values Ix1 and Iy1 are compared by the microcomputer 3, and the orientation of the digital camera 1 is determined to be landscape orientation as shown in FIG. 8. At this point the orientation determination signal 61 is “0,” for example.

As shown in FIG. 6B, in portrait orientation, since the yaw direction substantially coincides with the vertical direction, the yaw support frame 22 that supports the pitch support frame 21 and the second lens group L2 wants to go downward in the Y axis direction due to its own weight and the weight of these members. Since the second lens group L2 must be supported at a specific position (near the center of the optical axis AX, for example) in order to obtain a good image, current is supplied to the coil 24x at this point, and the yaw actuator 29x generates electromagnetic force for supporting the yaw support frame 22 on the fixing frame 25. As shown in FIG. 7, the current value at this point is termed Ix2, for example.

Meanwhile, since the pitch direction substantially coincides with the vertical direction, the pitch actuator 29y does not need to generate any extra electromagnetic force to support the weight of the pitch support frame 21 or the second lens group L2. Therefore, the current value Iy2 supplied to the coil 24y is smaller than the current value Ix1 supplied to the coil 24x. Therefore, orientation of the digital camera 1 is determined by the microcomputer 3 to be portrait orientation as shown in FIG. 8. At this point the orientation determination signal 61 is “1,” for example.

As discussed above, the value of the current supplied to the coils 24x and 24y varies according to the orientation of the digital camera 1 during photography. That is, the orientation of the digital camera 1 during photography can be ascertained by detecting the value of the current supplied to the coils 24x and 24y. Therefore, the blur correction device 20 is a mechanism for suppressing the degradation of images caused by movement of the digital camera 1 (called hand shake), and can also be utilized as an orientation detector for the digital camera 1.

Sequential Capture Mode

The digital camera 1 has two photography modes: normal mode and sequential capture mode. The sequential capture mode allows a predetermined number of images to be continuously acquired merely by pressing the shutter button 36 one time. Switching to the sequential capture mode is performed with the menu setting button 39, for example.

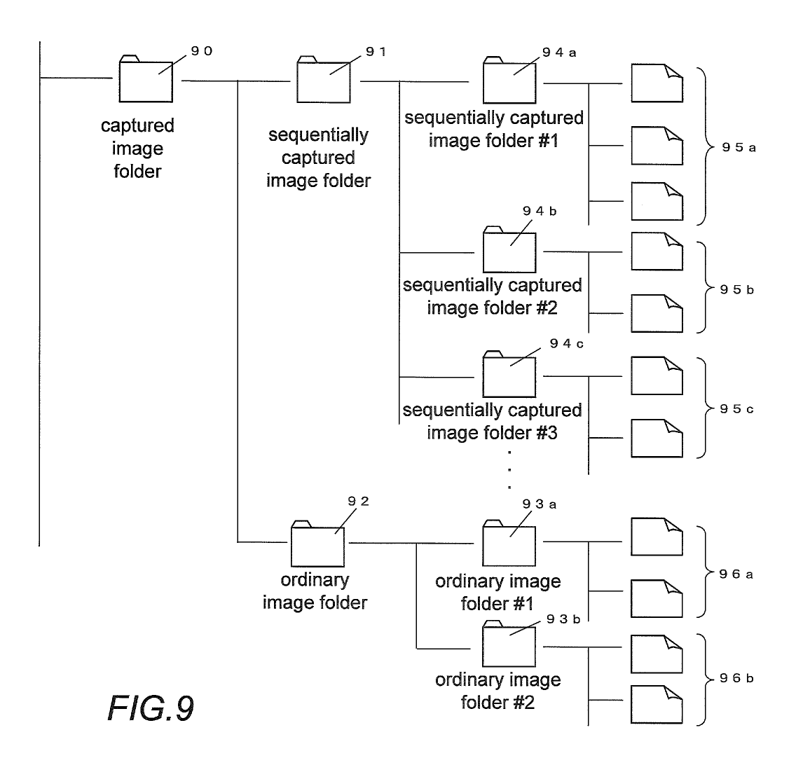

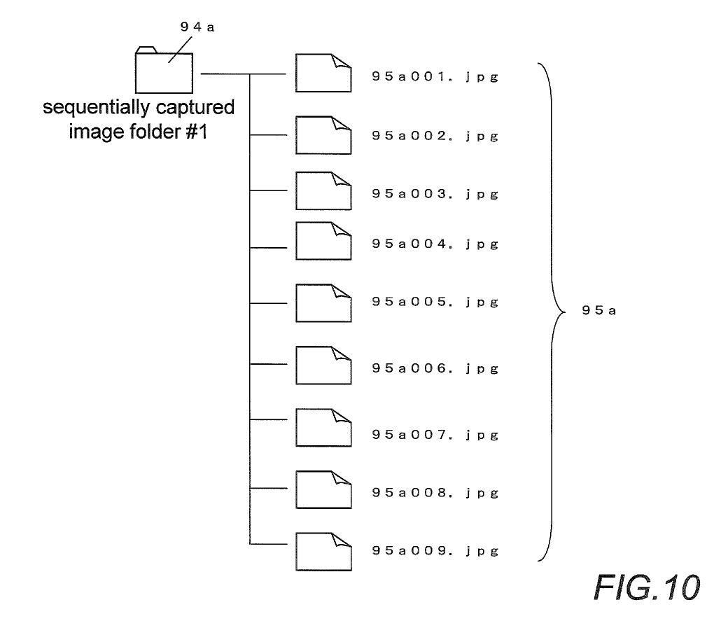

The method for managing image files will be described through reference to FIGS. 9 and 10. As shown in FIG. 9, an image folder 90 is formed in the internal memory 50 or the removable memory 51, and a sequentially captured image folder 91 and a normal image folder 92 are formed at a lower hierarchical level. Further, sequentially captured image folders 94a, 94b, 94c, etc., are formed at a lower hierarchical level under the sequentially captured image folder 91, and normal image folders 93a, 93b, etc., are formed at a lower hierarchical level under the normal image folder 92.

In sequential capture mode, a plurality of images acquired in one series of sequential shooting are stored in the sequentially captured image folder 94a as a plurality of image files 95a along with the orientation determination signal 61 and the panning mode signal 60. Similarly, a plurality of sequentially captured image files 95b are stored in the sequentially captured image folder 94b, and a plurality of sequentially captured image files 95c are stored in the sequentially captured image folder 94c. Meanwhile, images captured in normal imaging mode are stored as image files 96 in the normal image folders 93a, 93b, etc.

As shown in FIG. 10, nine image files are recorded in one series of sequential shooting to the sequentially captured image folder 94a, and file names of “001,” “002,” and so on are assigned in the order of the time of capture. The number of images acquired in one series of sequential shooting is not limited to nine.

Because the plurality of images acquired in sequential capture mode are thus stored in a single folder, related images are easier to identify.

Determining Method for Slideshow Display of Images

With this digital camera 1, the method for creating a slideshow display of the sequentially captured images displayed on the display unit 55 is decided by the microcomputer 3 on the basis of the above-mentioned panning mode signal 60. More specifically, the microcomputer 3 decides the method for a slideshow display of the plurality of images so that the movement direction of the images displayed in the slideshow will coincide with one component of the direction of the panning operation, according to the type of panning mode signal 60 corresponding to the plurality of sequentially captured images.

More specifically, the user selects a group of sequentially captured images to be displayed in a slideshow, and the selected group of sequentially captured images is temporarily acquired by the microcomputer 3 from the image recorder 12 via the image recording controller 11. Here, the panning mode signal 60 and the orientation determination signal 61 recorded along with the images are also acquired by the microcomputer 3.

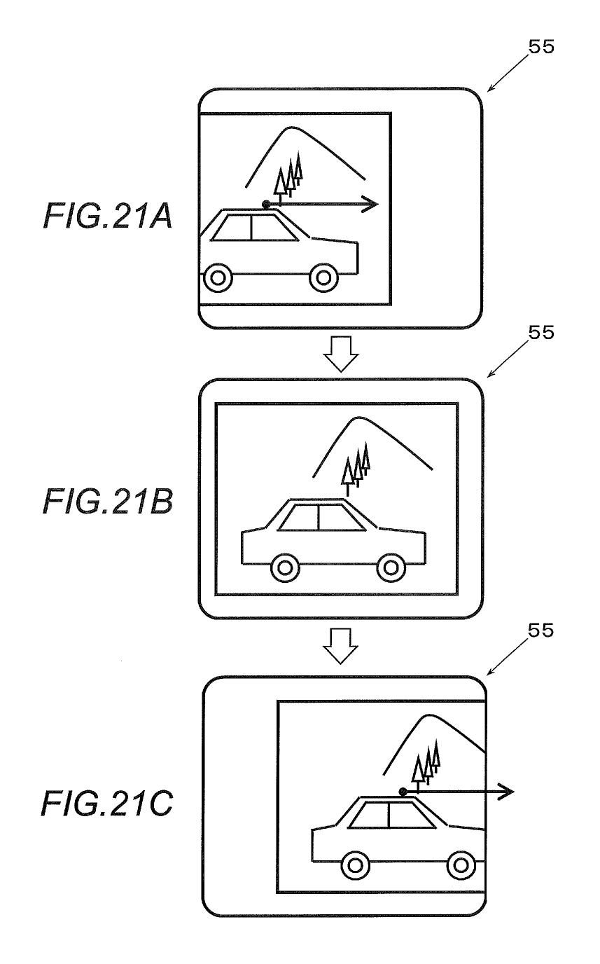

After the acquisition of the of group of sequentially captured images, with this digital camera 1, as shown in FIG. 21, for example, images captured while panning to the left are displayed as a slideshow so that they move to the left on the screen of the display unit 55, and as shown in FIG. 21, images captured while panning to the right are displayed as a slideshow so that they move to the right on the screen of the display unit 55.

The movement direction of the images on the display unit 55 is determined by the direction determination section 48 of the microcomputer 3 on the basis of the panning mode signal 60. More specifically, the panning mode signal 60 and the orientation determination signal 61 are temporarily acquired along with the group of sequentially captured images by the microcomputer 3. If the panning mode signal 60 corresponding to the image scheduled to be displayed next indicates that the panning direction is substantially to the left, then the direction determination section 48 produces a control signal indicating that the images on the screen of the display unit 55 move from the right to the left, and sends this signal to the image display controller 13. If the panning mode signal 60 indicates that the panning direction is other than to the left, the direction determination section 48 produces a control signal indicating that the images on the screen of the display unit 55 move from the left to the right, and sends this signal to the image display controller 13. That is, the direction determination section 48 converts the panning mode signal 60 produced by the movement determination section 46 into a control signal for the image display controller 13 indicating the slide-in and slide-out directions. The display unit 55 is controlled by the image display controller 13 on the basis of these control signals.

Also, the display state of the display unit 55 is adjusted by the image display controller 13 on the basis of the orientation determination signal 61 corresponding to the image scheduled to be displayed next. More specifically, the orientation determination section 47 produces a control signal indicating the orientation of the images with respect to the display unit 55, so that the height direction within the images substantially coincides with the vertical direction. The orientation of the displayed images is adjusted by the image display controller 13 on the basis of this control signal.

Thus, with this digital camera 1, the movement direction of the images displayed as a slideshow can be made to coincide substantially with the direction of panning, and the orientation of the images displayed as a slideshow can be adjusted on the basis of the orientation of the digital camera 1 during imaging, so the images displayed in the slideshow will not appear strange to the user.

Operation of Digital Camera

Next, the operation of the digital camera 1 will be described through reference to FIGS. 1 to 8.

When the user wants to capture an image, first the power switch 35 is turned on, and the mode switching dial 37 is switched to imaging mode. This puts the digital camera 1 in an imaging state. In this imaging state, movement of the digital camera 1 is detected by the angular velocity sensors 17x and 17y. The microcomputer 3 sends command signals to the yaw drive controller 15x and pitch drive controller 15y to cancel out any hand shake or the like that occurs. Current corresponding to these command signals is supplied to the coils 24x and 24y of the pitch support frame 21. The pitch support frame 21 is moved within the X-Y plane, perpendicular to the optical axis AX, by the electromagnetic force generated by the actuators 27x and 27y and the supplied current. Specifically, the blur correction device 20 moves the second lens group L2 within a plane perpendicular to the optical axis AX. Also, the light receiving element 31 is used to detect the position of the pitch support frame 21. This allows the user to correct the optical image incident on the imaging sensor 4 via the optical system L, and makes it possible to acquire a good image with reduced blurring.

(1) Determining Orientation

The imaging orientation of the digital camera 1 is determined as follows. Here, we will let the reference orientation of the digital camera 1 be a landscape orientation, and will let the angle of rotation around the optical axis AX in landscape orientation be 0°. In this case, portrait orientation is a state in which the digital camera 1 is rotated 90° around the optical axis AX from the landscape orientation.

We will describe a case in which the user photographs a subject that is wider than it is tall, such as scenery, in landscape orientation. The orientation of the digital camera 1 is determined from the current detection values of the yaw current value detector 14x and the pitch current value detector 14y. In FIG. 7, when a photograph is taken in landscape orientation, that is, at an orientation of 0°, the value Ix1 of current supplied to the coil 24x of the blur correction device 20 and the value Iy1 of current supplied to the coil 24y are detected by the yaw current value detector 14x and the pitch current value detector 14y. The detected current values Ix1 and Iy1 are compared by the microcomputer 3. In this case, as shown in FIG. 7, since the current value Ix1 is smaller than the current value Iy1, the microcomputer 3 determines that the digital camera 1 is in landscape orientation.

When the user presses the shutter button 36 in this state, a horizontal still picture is acquired. The captured still pictures are recorded one after the other to the image recorder 12. Here, as shown in FIG. 8, the image recording controller 11 adds a “0,” which indicates that the imaging orientation of the digital camera 1 is landscape orientation (0°), as the orientation determination signal 61 to the image signal outputted from the buffer memory 9. This orientation determination signal 61 is recorded to the header or footer portion of the image signal, for example. The recording of the orientation determination signal 61 may be carried out when the image signal is outputted from the buffer memory 9, or may be carried out at the image recorder 12 after the image signal has been recorded to the image recorder 12.

Meanwhile, when the user wants to photograph a subject that is taller than it is wide, such as a person, in portrait orientation, just as in the case of landscape orientation, the orientation of the digital camera 1 is determined by the microcomputer 3 on the basis of the current values detected by the yaw current value detector 14x and the pitch current value detector 14y. In FIG. 7, when a photograph is taken in portrait orientation, the value Ix2 of current supplied to the coil 24x of the blur correction device 20 and the value Iy2 of current supplied to the coil 24y are detected by the yaw current value detector 14x and the pitch current value detector 14y. The detected current values Ix2 and Iy2 are compared by the microcomputer 3. In this case, as shown in FIG. 7, since the current value Iy2 is smaller than the current value Ix2, the microcomputer 3 determines that the digital camera 1 is in portrait orientation.

When the user presses the shutter button 36 in this state, a vertical image is acquired. The captured image is recorded to the image recorder 12. Here, the image recording controller 11 adds a “1,” which indicates that the photography orientation of the digital camera 1 is portrait orientation, as the orientation determination signal 61 to the image signal outputted from the buffer memory 9.

(2) Determining Panning Mode

Next, a case in which the user follows a moving subject to capture images sequentially by panning will be described.

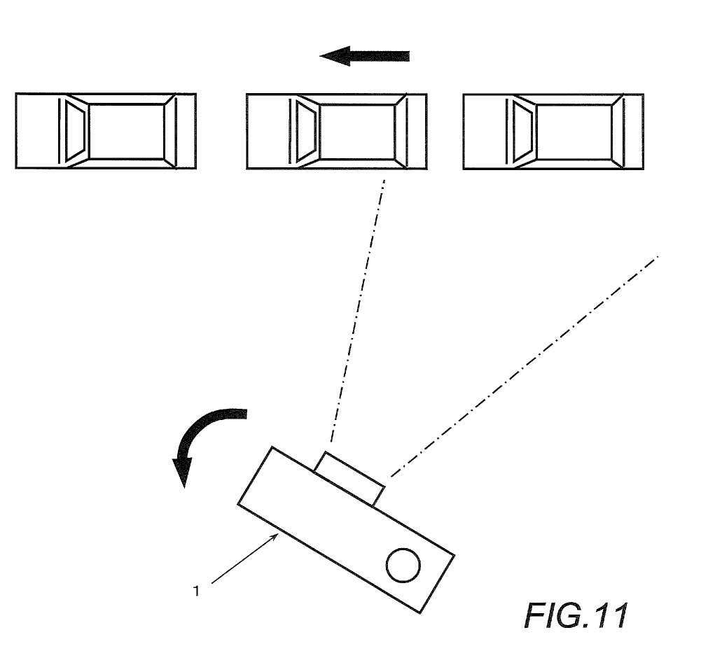

As shown in FIG. 11, when sequential images are captured of an automobile moving to the left, the user pans the digital camera 1 to the left and presses the shutter button 36 while tracking the movement of the automobile. As a result, a plurality of images sequentially captured by panning (nine images in this embodiment) are temporarily stored in the buffer memory 9 and recorded one after the other to the image recorder 12. At this point, the panning mode signal 60 is recorded along with the nine images.

Here, since the direction in which the digital camera 1 faces is changing to the left, the movement determination section 46 of the microcomputer 3 determines from the output signal of the angular velocity sensor 17y that vertical panning is “none,” and determines from the output signal of the angular velocity sensor 17x that horizontal panning is “to the left.” Consequently, “1” is recorded as the panning mode signal 60 along with the plurality of images to the image recorder 12.

Also, the above-mentioned orientation determination signal 61 is recorded along with the panning mode signal 60 to the image recorder 12. In this case, since the orientation of the digital camera 1 is landscape orientation, “0” is recorded as the orientation determination signal 61 along with each frame of images.

(3) Operation in Sequential Capture Mode

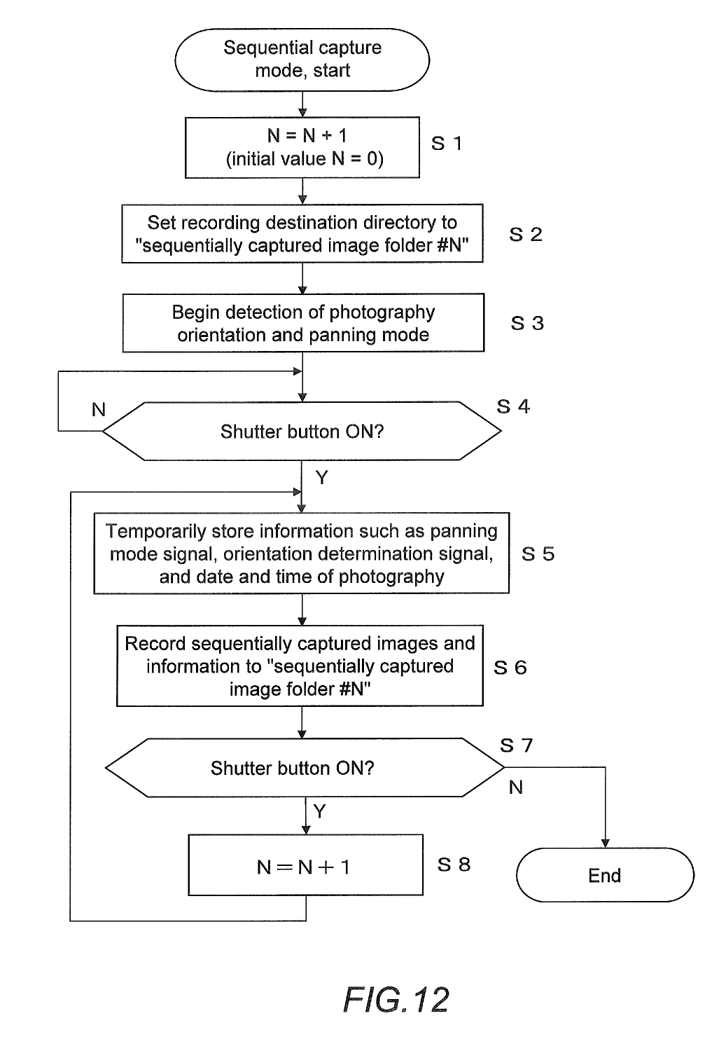

FIG. 12 is a flowchart of sequential capture mode, from the start of image recording until the recording ends. First, to set the camera to sequential capture mode, the user presses the menu setting button 39, and various menus are displayed on the display unit 55. The digital camera 1 changes to sequential capture mode when that mode is selected from among the various menus displayed.

When sequential capture mode has been selected, the microcomputer 3 adds 1 to a constant N of an initial value 0 (S1), and the directory to which the images will be recorded is set to sequentially captured image folder #1 (S2). The microcomputer 3 commences detection of the orientation determination signal 61 and the panning mode signal 60 of the digital camera 1 (S3). More specifically, the movement determination section 46 produces the panning mode signal 60, and the orientation determination section 47 produces the orientation determination signal 61.

Then, the system waits for the shutter button 36 to be pressed (S4), and when the shutter button 36 is pressed, the panning mode signal 60, the orientation determination signal 61, and various information such as the date and time of the imaging are temporarily stored (S5), and a plurality of images are continuously acquired at a specific timing (S6). Here, when the shutter button 36 is pressed once, nine images are captured sequentially, for example. The plurality of images acquired by sequential capture are recorded along with the various information mentioned above to the sequentially captured image folder #1 of the image recorder 12 (S6). More specifically, as shown in FIGS. 9 and 10, the plurality of images are stored as the image file 95a in the sequentially captured image folder 94a.

After this, it is determined whether or not the shutter button 36 still being held down (S7), and if the shutter button 36 is being pressed, 1 is added to the constant N (S8), and sequential capture and image recording are once again carried out (55, S6). If the shutter button 36 has not been pressed, the sequential capture mode is ended.

(4) Slideshow Operation in Reproduction Mode

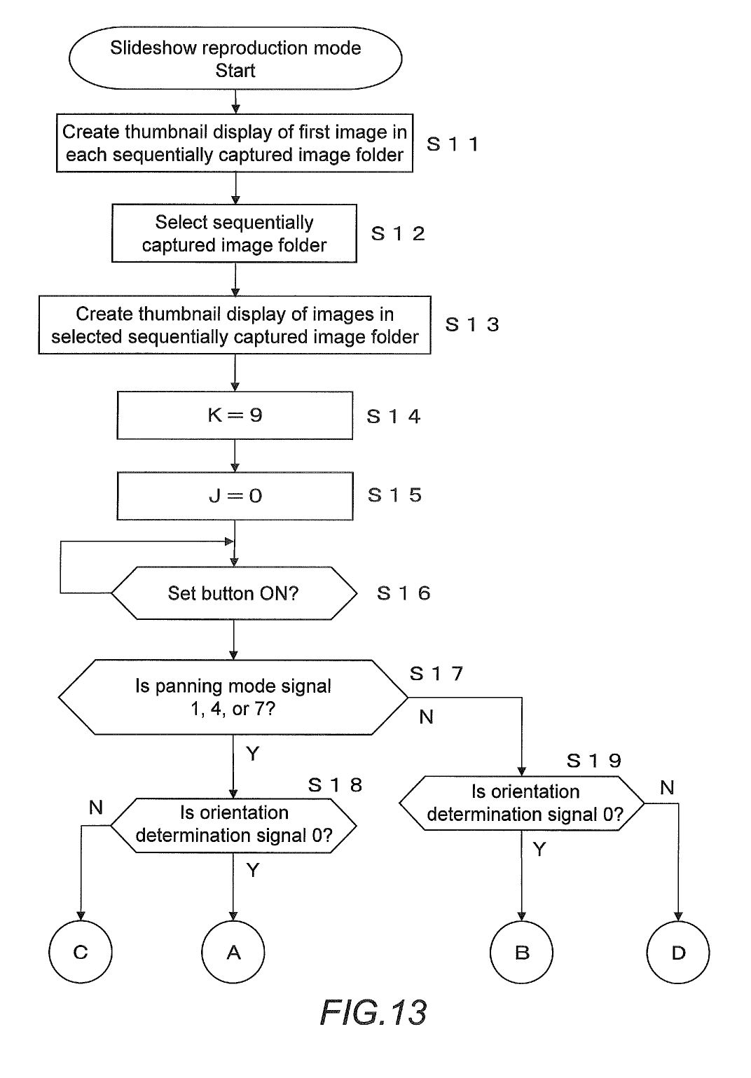

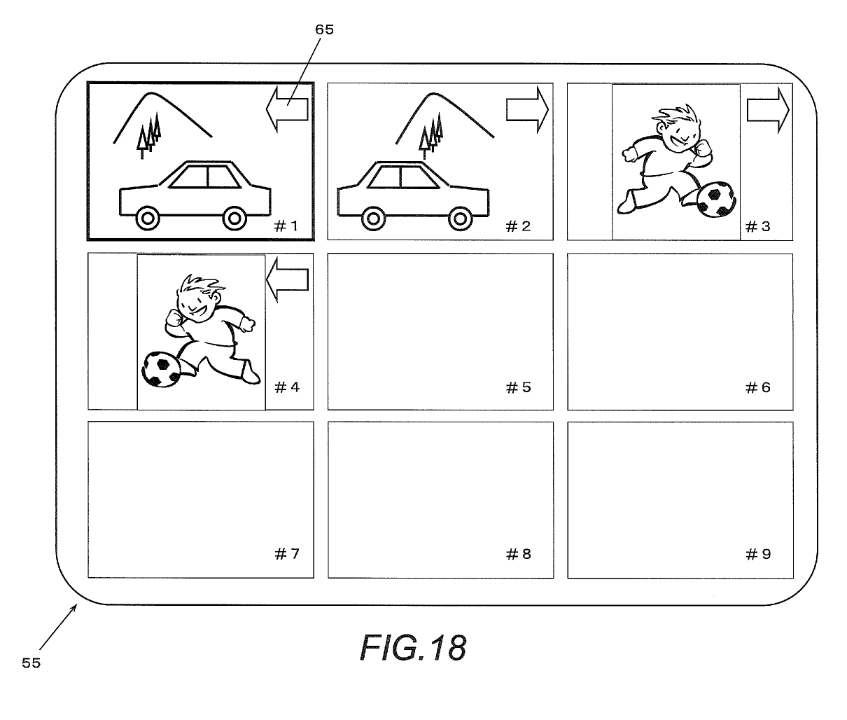

Next, the method for reproducing the obtained images when they are displayed as a slideshow on the display unit 55 will be described through reference to FIGS. 13 to 17. FIGS. 13 to 17 are flowcharts of the reproduction mode. FIG. 18 is an example of a thumbnail display of a sequentially captured image folder.

First, to produce a thumbnail display of the captured images on the display unit 55 for each image folder, after the power switch 35 is turned on, the mode switching dial 37 is turned to reproduction mode. This begins the reproduction mode.

As shown in FIG. 18, nine thumbnail images of the sequentially captured image folders #1 to #9 are displayed on the display unit 55 (S11). These sequentially captured image folders contain the panning mode signal 60 and the orientation determination signal 61 along with the images. For example, the plurality of images stored in the sequentially captured image folder #1 are images captured sequentially, while panning to the left, of an automobile moving to the left, while the digital camera 1 is in landscape orientation. Therefore, along with these images, “0” is recorded as the orientation determination signal 61, and “1” as the panning mode signal 60. The front image (the image acquired first) is displayed in thumbnail as a representative image. The direction indicated by the panning mode signal 60 may be displayed over the thumbnail images on the display unit 55 by using an arrow 65, for example.

Also, the plurality of images (group of sequentially captured images) stored in the sequentially captured image folder #2 are images captured sequentially while panning to the right, of an automobile moving to the right, with the digital camera 1 in landscape orientation. Therefore, along with these images, a “0” is recorded as the orientation determination signal 61, and a “2” as the panning mode signal 60.

The thumbnail images for the sequentially captured image folder #3 are images captured sequentially while panning to the right over a child moving to the right, with the digital camera 1 in portrait orientation. Therefore, a “1” is recorded as the orientation determination signal 61, and a “2” as the panning mode signal 60. The front image is displayed in thumbnail as a representative image on the display unit 55.

Here, the front image in the thumbnail display is displayed on the display unit 55 in a state of being restored to the same orientation as during photography, on the basis of the orientation determination signal 61. More specifically, when the orientation determination signal 61 is “0” (in the case of thumbnail images of the sequentially captured image folders #1 and #2 shown in FIG. 18), the image is captured in landscape orientation. Therefore, a control signal is sent from the microcomputer 3 to the image display controller 13 so that a horizontal image will be displayed on the display unit 55 when the digital camera 1 is in landscape orientation, and the operation of the display unit 55 is controlled by the image display controller 13. As a result, an image is displayed in horizontal format on the display unit 55. Also, when the orientation determination signal 61 is “1” (in the case of thumbnail images of the sequentially captured image folder #3 shown in FIG. 18), the image is captured in portrait orientation. Therefore, just as when the orientation determination signal 61 is “0,” a vertical image (an image rotated 90°) is displayed on the display unit 55 when the digital camera 1 is in landscape orientation. In FIG. 18, the thumbnail images for sequentially captured image folders #5 to #9 are not depicted.

Next, the cross control key 38 is used to select a sequentially captured image folder from among the front images of the image folders in thumbnail display (S12). The folder is selected using the cross control key 38 and the set button 40. When the sequentially captured image folder #1 shown in FIG. 18 is selected, the group of sequentially captured images in the sequentially captured image folder #1 is temporarily acquired by the microcomputer 3 via the image recording controller 11, and the nine thumbnail images of the sequentially captured image folder #1 are displayed on the display unit 55 via the image display controller 13 (S13). At this point, the microcomputer 3 also temporarily acquires the panning mode signal 60 and orientation determination signal 61 recorded to the image recorder 12 along with the group of sequentially captured images. Here, the microcomputer 3 inputs the nine sequentially captured images as a reference number K (S14), and inputs an initial value of 0 as a display count number J (S15).

Next, the cross control key 38 is used to select the slideshow display mode (not shown), and the set button 40 is used to start the slideshow display (S16).

To optimize the slideshow display of the images according to the panning operation during imaging, the panning mode signal 60 is confirmed by the microcomputer 3 (S17). More specifically, the microcomputer 3 determines whether the panning mode signal 60 acquired along with the group of sequentially captured images is “1,” “4,” or “7” (S17). These panning mode signals 60 mean that the camera is being panned at least to the left, so if this condition is met, the microcomputer 3 adjusts the slideshow display of the images through the image display controller 13 so that the images move from right to left within the screen of the display unit 55. If this condition is not met, the microcomputer 3 adjusts the slideshow display of the images through the image display controller 13 so that the images move from left to right within the screen of the display unit 55.

Also, after the confirmation of the panning mode signal 60, the orientation determination signal 61 acquired along with the group of sequentially captured images is checked (S18, S19). More specifically, the microcomputer 3 determines whether or not the orientation determination signal 61 is “0” (S18, S19). If the orientation determination signal 61 is “0,” then sequential capture is being performed in landscape orientation, so a horizontal image is displayed on the display unit 55 in order to restore the view to the orientation during imaging. Meanwhile, if the orientation determination signal 61 is “1,” then sequential capture is being performed in portrait orientation, so a vertical image is displayed on the display unit 55 in a state of 90° rotation order to restore the view to the orientation during imaging.

The flow will now be described in detail for every condition of step S17.

A) In Landscape Orientation

### When the Panning Horizontal Component is “To the Left”

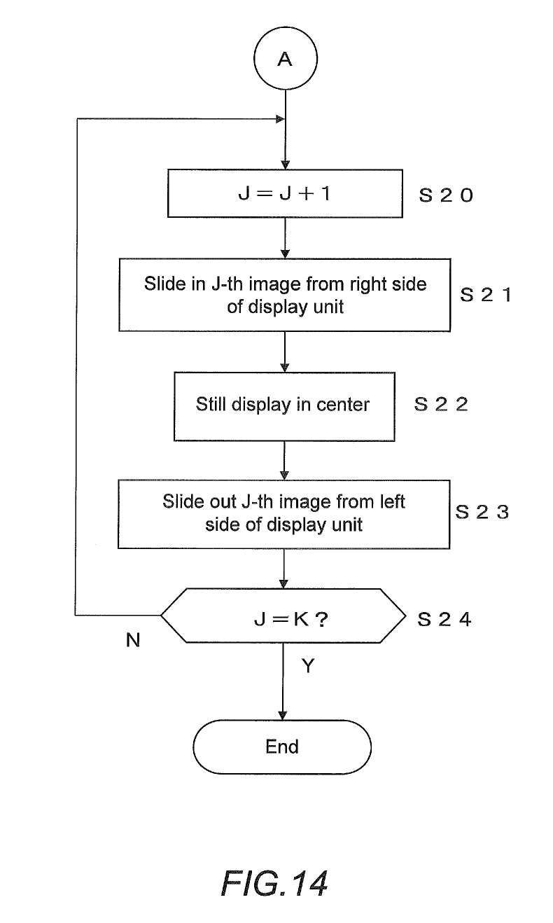

When the sequentially captured image folder #1 has been selected, for example, since the imaging is performed in landscape orientation while panning to the left, the microcomputer 3 determines that the panning mode signal 60 in step S17 is either “1,” “4,” or “7,” and the microcomputer 3 determines that the orientation determination signal 61 in step S18 is “0.” As a result, a slideshow display of the images is performed on the basis of the flow A shown in FIG. 14.

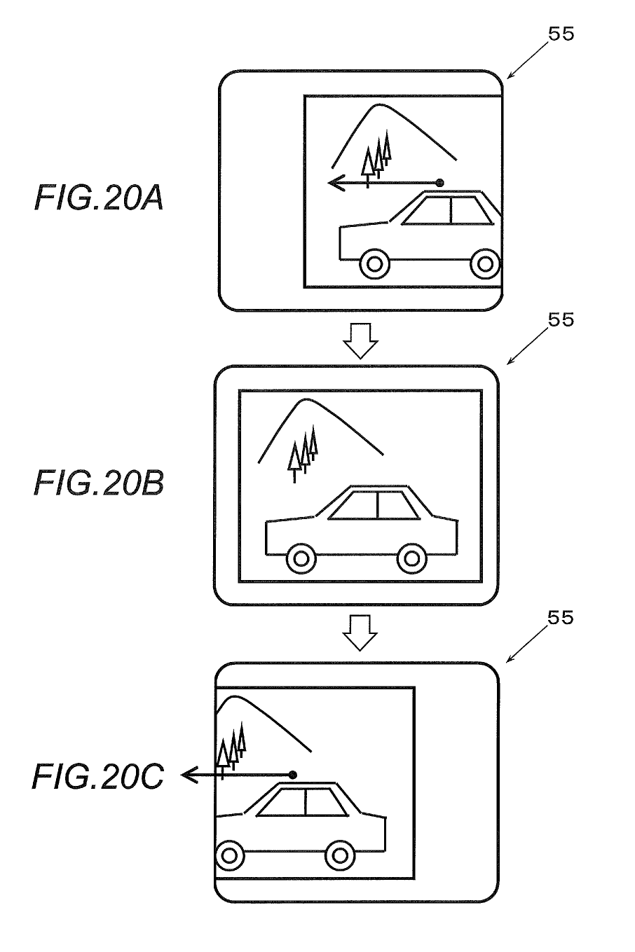

More specifically, as shown in FIG. 14, the microcomputer 3 adds 1 to the display count number J (S20), and the image display controller 13 creates a slideshow display on the display unit 55, starting from the J-th (that is, the first) image. In this case, the image is in landscape orientation, and the panning signal indicates “to the left,” so as shown in FIGS. 20A to 20C, the images are slid in from the right side of the display unit 55 (S21; see FIG. 20A), an image that has reached the center is stopped and displayed for a specific time (S22; see FIG. 20B), and the image is then slid out from the left side of the display unit 55 (S23; FIG. 20C). That is, in sliding in and out, the images move to the left within the screen of the display unit 55.

Steps S21 to S23 are repeated until the display count number J reaches the reference number K (that is, until the slideshow display of all nine images is finished) (S24). When the slideshow display of all nine images is finished, the slideshow display processing is ended, and the display state of the display unit 55 returns to the thumbnail display screen shown in FIG. 18.

Thus, with this digital camera 1, when a plurality of sequentially captured images are displayed as a slideshow, the display direction of the images is automatically adjusted by the microcomputer 3 so that the panning direction (the movement direction of the subject) will substantially coincide with the direction in which the images are displayed (the slide-in and slide-out directions). Therefore, when a plurality of sequentially captured images are displayed as a slideshow, the display can be matched to the actual movement direction, and even with a still picture, it can be displayed in an intuitive way that matches the movement of the subject. This means that the images displayed in the slideshow will not appear strange to the user.

When the Panning Horizontal Component is “to the Right” or “None”

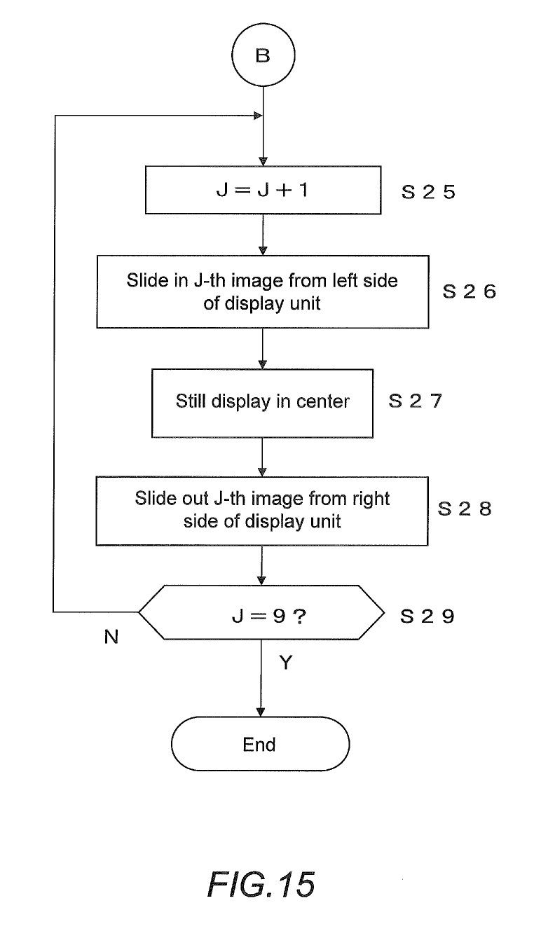

When the sequentially captured image folder #2 has been selected, for example, since the imaging is performed in landscape orientation while panning to the right, the microcomputer 3 determines that the panning mode signal 60 in step S17 is either “1,” “4,” or “7,” and the microcomputer 3 determines that the orientation determination signal 61 in step S19 is “0.” As a result, a slideshow display of the images is performed on the basis of the flow B shown in FIG. 15.

More specifically, as shown in FIG. 15, the microcomputer 3 adds 1 to the display count number J (S25), and the image display controller 13 creates a slideshow display on the display unit 55, starting from the J-th (that is, the first) image. In this case, the image is in landscape orientation, and the panning signal indicates “to the right,” so as shown in FIGS. 21A to 21C, the images are slid in from the left side of the display unit 55 (S26; see FIG. 21A), an image that has reached the center is stopped and displayed for a specific time (S27; see FIG. 21B), and the image is then slid out from the right side of the display unit 55 (S28; FIG. 21C). That is, in sliding in and out, the images move to the right within the screen of the display unit 55.

Steps S26 to S28 are repeated until the display count number J reaches the reference number K (that is, until the slideshow display of all nine images is finished) (S29). When the slideshow display of all nine images is finished, the slideshow display processing is ended, and the display state of the display unit 55 returns to the thumbnail display screen shown in FIG. 18.

Thus, with this digital camera 1, when a plurality of sequentially captured images are displayed as a slideshow, the display direction of the images is automatically adjusted by the microcomputer 3 so that the panning direction (the movement direction of the subject) will substantially coincide with the direction in which the images are displayed (the slide-in and slide-out directions). Therefore, when a plurality of sequentially captured images are displayed as a slideshow for the user, the display can be matched to the actual movement direction, and even with a still picture, it can be displayed in an intuitive way that matches the movement of the subject. This means that the images displayed in the slideshow will not appear strange to the user.

B) In Portrait Orientation

When the Panning Horizontal Component is “to the Left”

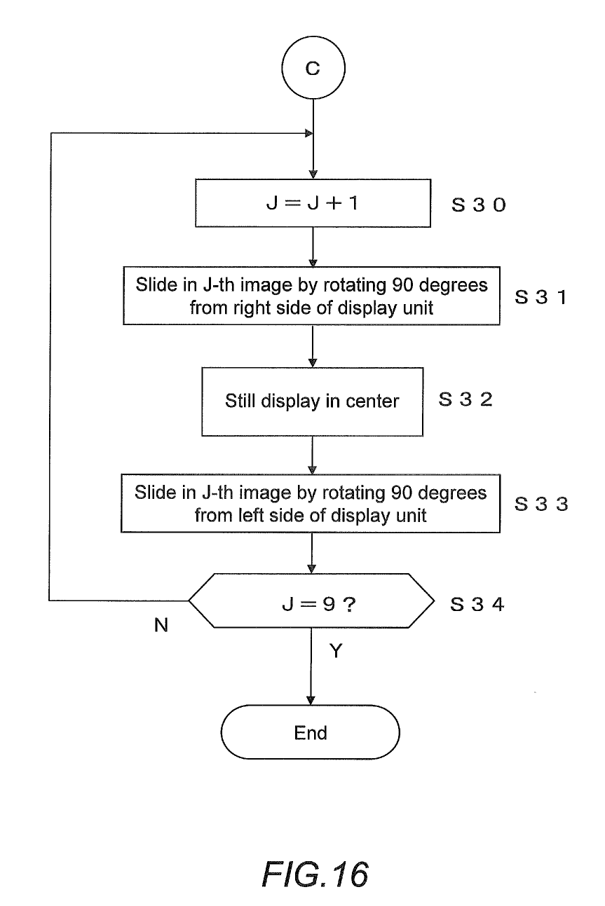

When the sequentially captured image folder #4 has been selected, for example, since the imaging is performed in portrait orientation while panning to the left, the microcomputer 3 determines that the panning mode signal 60 in step S17 is either “1,” “4,” or “7,” and the microcomputer 3 determines that the orientation determination signal 61 in step S18 is not “0.” As a result, a slideshow display of the images is performed on the basis of the flow C shown in FIG. 16.

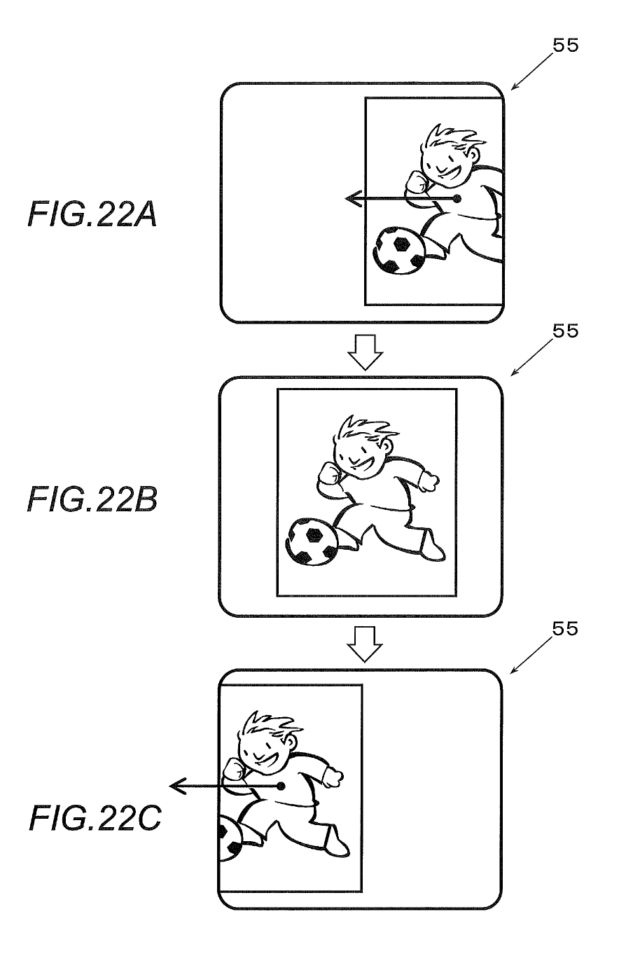

More specifically, as shown in FIG. 16, the microcomputer 3 adds 1 to the display count number J (S30), and the image display controller 13 creates a slideshow display on the display unit 55, starting from the J-th (that is, the first) image. In this case, the image is in portrait orientation, and the panning signal indicates “to the left,” so as shown in FIGS. 22A to 22C, the images are slid in from the right side of the display unit 55 (S31; see FIG. 22A) in a state in which the images have been rotated 90° with respect to the display unit 55 using the horizontal state as a reference, an image that has reached the center is stopped and displayed for a specific time (S32; see FIG. 22B), and the image is then slid out from the left side of the display unit 55 (S33; FIG. 22C). That is, in sliding in and out, the images move to the left within the screen of the display unit 55 with the images in a vertical state (a state in which the height direction within an image substantially coincides with the vertical direction).

Steps S31 to S33 are repeated until the display count number J reaches the reference number K (that is, until the slideshow display of all nine images is finished) (S34). When the slideshow display of all nine images is finished, the slideshow display processing is ended, and the display state of the display unit 55 returns to the thumbnail display screen shown in FIG. 18, for example.

When the Panning Horizontal Component is “to the Right” or “None”

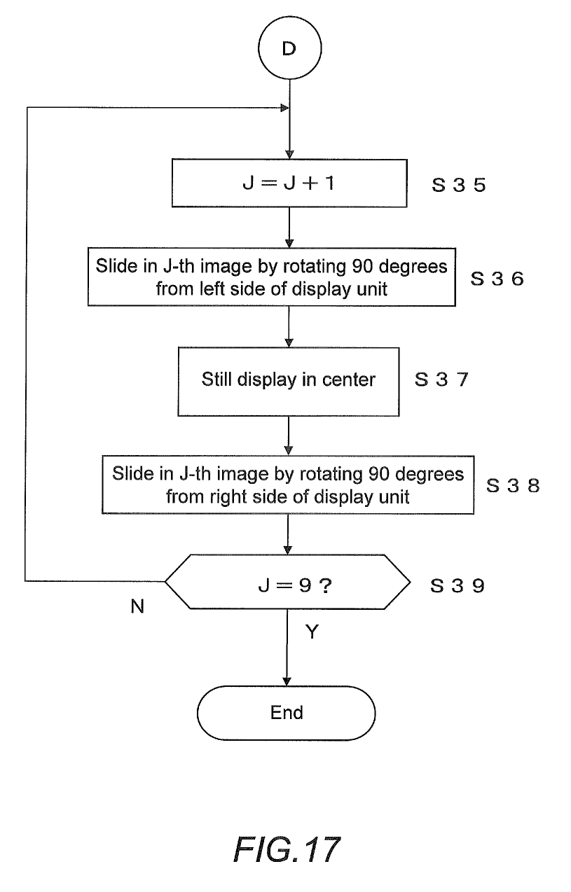

When the sequentially captured image folder #3 has been selected, for example, since the imaging is performed in portrait orientation while panning to the right, the microcomputer 3 determines that the panning mode signal 60 in step S17 is either “1,” “4,” or “7,” and the microcomputer 3 determines that the orientation determination signal 61 in step S19 is “0.” As a result, a slideshow display of the images is performed on the basis of the flow D shown in FIG. 17.

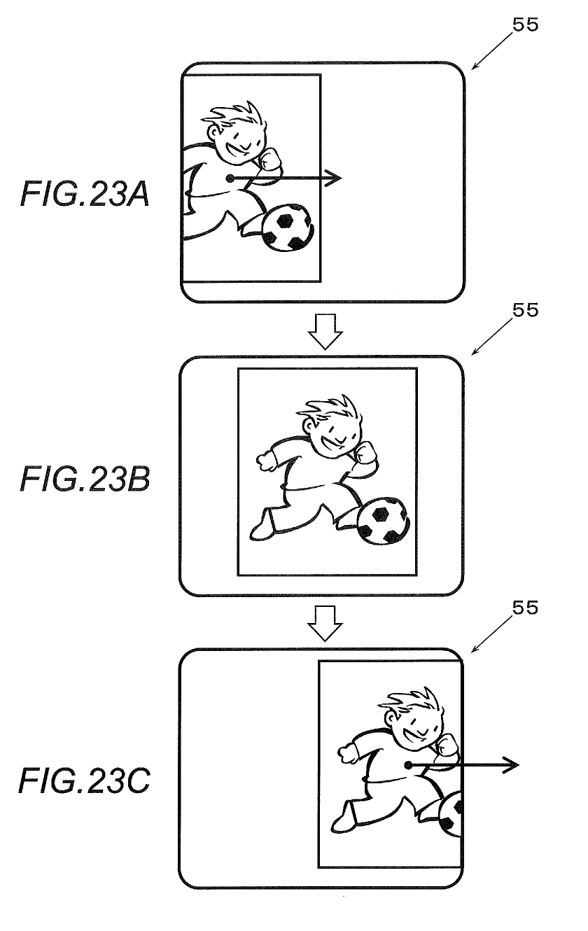

More specifically, as shown in FIG. 17, the microcomputer 3 adds 1 to the display count number J (S35), and the image display controller 13 creates a slideshow display on the display unit 55, starting from the J-th (that is, the first) image. In this case, the image is in portrait orientation, and the panning signal indicates “to the right,” so as shown in FIGS. 23A to 23C, the images are slid in from the left side of the display unit 55 (S36; see FIG. 23A) in a state in which the images have been rotated 90° with respect to the display unit 55 using the horizontal state as a reference, an image that has reached the center is stopped and displayed for a specific time (S37; see FIG. 23B), and the image is then slid out from the right side of the display unit 55 (S38; FIG. 23C). That is, in sliding in and out, the images move to the right within the screen of the display unit 55 with the images in a vertical state (a state in which the height direction within an image substantially coincides with the vertical direction).

Steps S36 to S38 are repeated until the display count number J reaches the reference number K (more precisely, until the slideshow display of all nine images is finished) (S39). When the slideshow display of all nine images is finished, the slideshow display processing is ended, and the display state of the display unit 55 returns to the thumbnail display screen shown in FIG. 18, for example.

Features

The features of the digital camera 1 are as follows.

(1)

With this digital camera 1, as described above, the microcomputer 3 determines the movement direction of images on the display unit 55 on the basis of the panning mode signal 60, which indicates the movement of the digital camera 1 (movement of the housing 1a) during imaging. The image display controller 13 displays images on the display unit 55 so that the images move over the screen of the display unit 55 on the basis of movement direction determined by the microcomputer 3. With this constitution, the movement direction of the images over the screen of the display unit 55 can be made to coincide substantially with the direction in which the digital camera 1 was moved during imaging. This means that the images displayed in the slideshow will not appear strange to the user.

In particular, since the microcomputer 3 determines the movement direction of the images so that the movement direction of the images on the display unit 55 will coincide with one component of the direction of movement indicated by the panning mode signal 60, it is more likely that the movement direction of the images on the screen of the display unit 55 will substantially coincide with the direction in which the digital camera 1 moved during imaging.

The reason for the wording of the phrase “the movement direction of the images on the display unit 55 will coincide with one component of the direction of movement indicated by the panning mode signal 60” is that even if the movement direction of the images does not completely coincide with the direction of movement indicated by the panning mode signal 60, as long as the movement direction of the images substantially coincides with the direction of movement indicated by the panning mode signal 60, the images displayed in the slideshow will not look strange to the user. For example, as shown in FIG. 12, if the user pans the digital camera 1 upward and to the left, or downward and to the left, the movement direction of the images (to the left) will coincide with one component of the direction in which the digital camera 1 moves (the horizontal component of the panning direction, that is, to the left) as shown in FIG. 20, so the movement will not look strange.

(2)

With this digital camera 1, the vertical and horizontal components of panning are detected by the yaw angular velocity sensor 17x and the pitch angular velocity sensor 17y. Furthermore, the panning mode signal 60 is automatically produced by the microcomputer 3 on the basis of these detection results, and the panning mode signal 60 is recorded to the image recorder 12 along with a plurality of sequentially captured images. As a result, the angular velocity sensors 17x and 17y used for blur correction can be utilized as part of the detection component used for producing the panning mode signal 60.

(3)

With this digital camera 1, the state in which the images are displayed on the display unit 55 is adjusted by the microcomputer 3 and the image display controller 13 so that the height direction in the images when the images are displayed on the display unit 55 substantially coincides with the vertical direction on the basis of the orientation determination signal 61 serving as the orientation information. That is, the images are displayed on the display unit 55 in the same state as that during imaging. Accordingly, the height direction of the actual subject and the height direction of the subject in the images can be made to coincide substantially, which allows any unnaturalness of the displayed images to be reduced.

### Second Embodiment

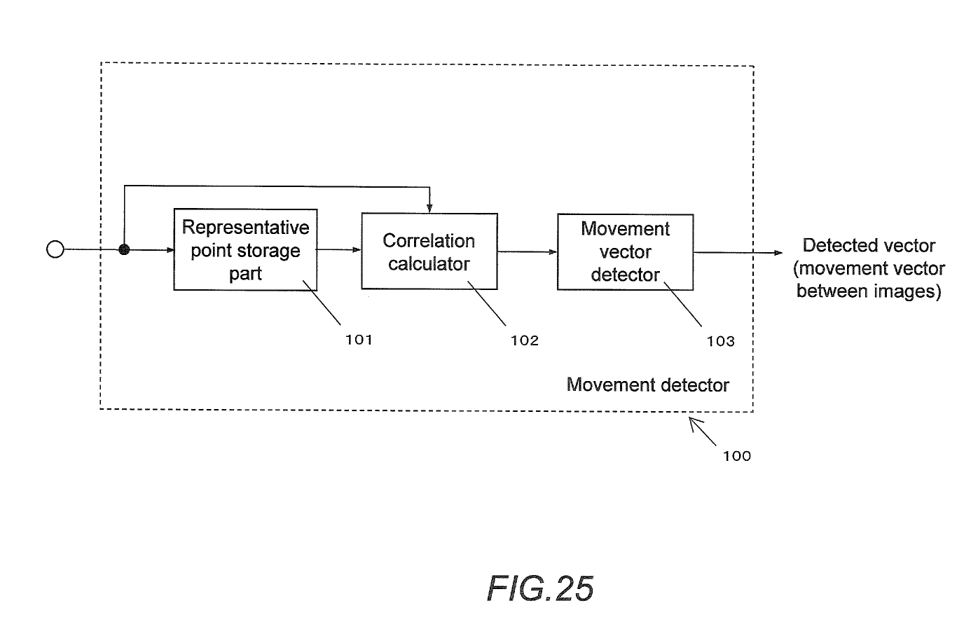

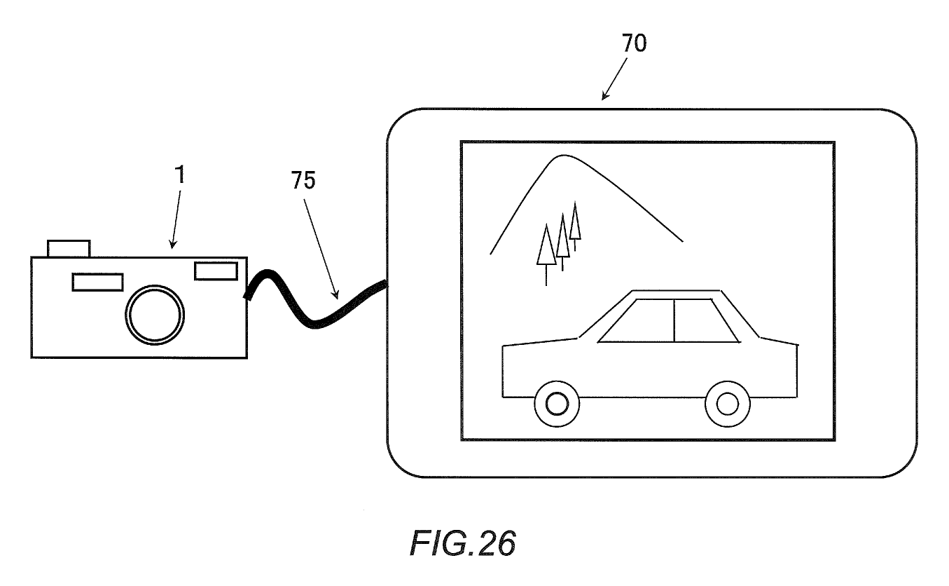

In the embodiment given above, a case was described of panning the digital camera 1 to capture images sequentially. However, as shown in FIG. 25, it is also conceivable that sequential images of a moving subject are captured without panning the digital camera 1. FIG. 26 is a block diagram illustrating an example of the configuration of a movement detector. Those components that have substantially the same function as in the above embodiment are numbered the same, and will not be described again.

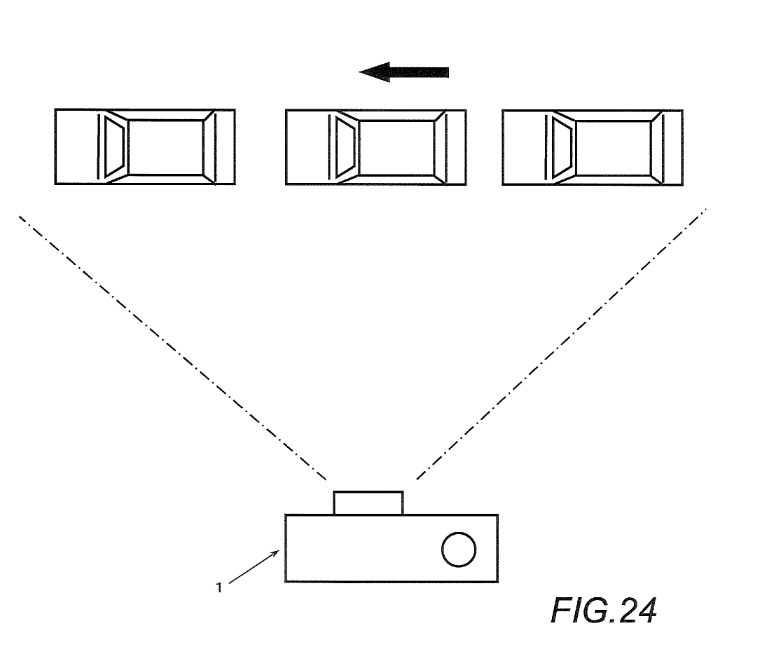

FIG. 24 depicts a situation in which images of an automobile moving to the left are sequentially captured over a wide angle of view, with the imaging orientation of the digital camera 1 in substantially the same state. Here, instead of the panning mode signal 60 used in the first embodiment, the image display method is determined on the basis of the movement vector of the subject detected from the images. Just as with the panning mode signal 60 shown in FIG. 5, a movement vector signal 62 that indicates movement of the subject is produced by a movement detector 100 and the microcomputer 3.

More specifically, as shown in FIG. 25, the movement detector 100 is a unit for detecting movement of the subject within images on the basis of a plurality of images, and has a representative point storage part 101, a correlation computer 102, and a movement vector detector 103.

The representative point storage part 101 divides an image signal for the current frame inputted via the A/D converter 7 and the digital signal processor 8 into a plurality of regions, and stores the image signals corresponding to a specific representative point included in each region as representative point signals. The representative point storage part 101 reads the representative point signal one frame ahead of the current frame that has already been stored, and outputs it to the correlation computer 102.

The correlation computer 102 computes the correlation between the representative point signal one frame earlier and the representative point signal of the current frame, and compares the difference between the representative point signals. The computation result is outputted to the movement vector detector 103.

The movement vector detector 103 detects the movement vector of an image between one frame earlier and the current frame, in single pixel units, from the computation result supplied by the correlation computer 102. The movement vector is then outputted to the microcomputer 3. The microcomputer 3 adjusts the movement vector for gain, phase, etc., and calculates the direction and speed of movement per unit of time of the subject in the image signal. Depending on the direction in which the subject is moving, the movement vector signal 62 is produced as a signal from “0” to “8,” as with the panning mode signal 60 shown in FIG. 5.

Just as in the embodiment above, the image display direction is determined by the microcomputer 3 on the basis of the movement vector signal 62. How this is determined is the same as in the embodiment above, and will therefore not be described again in detail.

The processing of detecting subject movement is commenced, for example, when the user presses the shutter button 36 half-way. Processing may begin in conjunction with the operation of the mode switching dial 37 to switch to photography mode after the user has turned off the power switch 35.

With the above configuration of the digital camera 1, the method for creating a slideshow display of images is determined by the microcomputer 3 on the basis second movement information, from images for which the movement vector signal 62 (an example of second movement information) is recorded. More specifically, the microcomputer 3 determines the slideshow display method (more precisely, the movement direction of images on the display unit 55) so that the movement direction of images on the screen of the display unit 55 substantially coincides with the direction of movement of the subject indicated by the movement vector signal 62. This means that the images displayed in the slideshow will not appear strange to the user.

Also, a subject face detector may be provided to the digital camera 1 so that the movement vector detection can be determined on the basis of movement information about the face of the subject. In this case, the direction determination section 48 of the microcomputer 3 determines the method for displaying a slideshow of the images so that the movement direction of images on the screen of the display unit 55 will substantially coincide with the orientation of the subject's face (such as to the left or to the right).

### Third Embodiment

In the above embodiments, the images were displayed on the display unit 55, but as shown in FIG. 26, it is also conceivable that the images are displayed on a display device 70 connected to the digital camera 1.

In this case, the only difference is that the display unit has been changed from the display unit 55 to the display device 70 (a television monitor or the like), and this embodiment is the same as those given above in that the microcomputer 3 determines the movement direction and display state of the images on the basis of the panning mode signal 60, the orientation determination signal 61, the movement vector signal 62, or other such information. The display device 70 is connected to the digital camera 1 via a cable 75. The cable 75 is, for example, a USB (Universal Serial Bus) cable.

The above configuration is valid when no display unit is provided to the digital camera, or when the images are to be displayed in a larger size. This makes possible a better display that is easier to view.

Furthermore, in the third embodiment, a television monitor was given as an example of the external display device 70, but the device is not limited to this. For example, it may be connected via the cable 75 to a personal computer connected to a monitor.

Furthermore, in the third embodiment, the use of a USB cable was given as an example of the cable 75, but other options are also possible. For instance, the connection can be made with an IEEE 1394 serial bus cable, or may be a wireless connection with a wireless LAN or the like.

### Fourth Embodiment

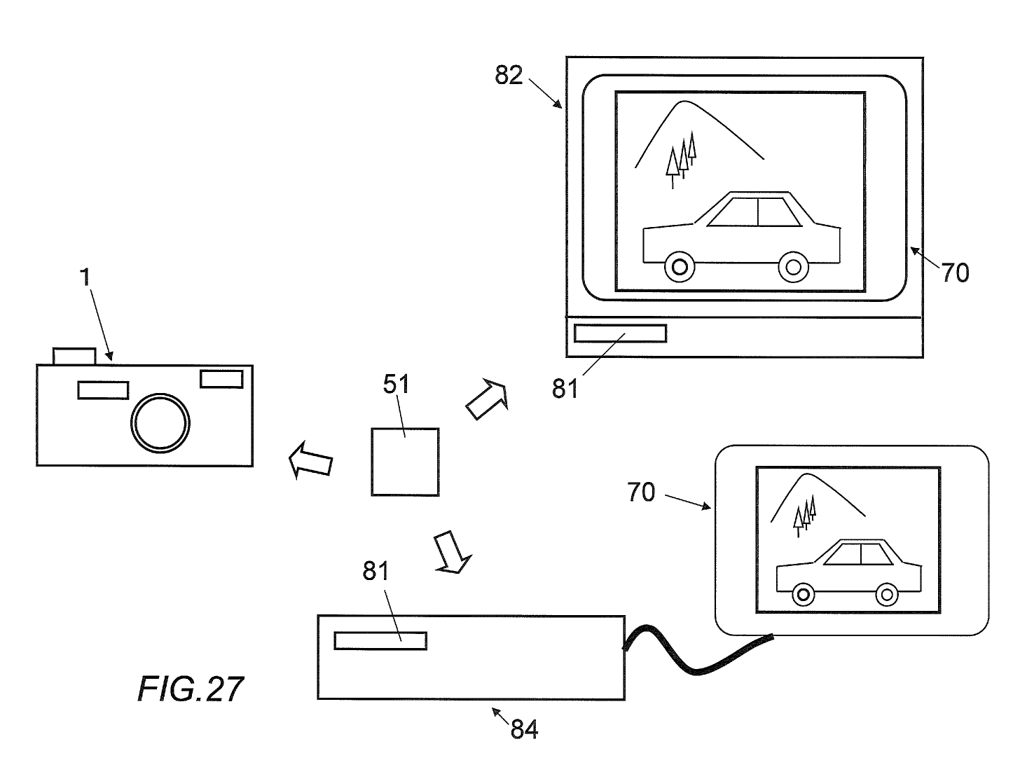

In this case, display is controlled by a display control device 82. More specifically, as shown in FIG. 27, the display control device 82 is a personal computer equipped with image processing software, for example. An image captured by the digital camera 1 is recorded to the removable memory 51 (such as a memory card) along with information such as thumbnail images, the orientation determination signal 61, the palming mode signal 60, or the movement vector signal 62. The removable memory 51 is not limited to being a memory card, and may instead be a hard disk, an optical disk, or the like.

The display control device 82 has a removable memory insertion unit 81 with which information recorded to the removable memory 51 can be read, and the display device 70 on which images are displayed. Just as in the first embodiment above, the layout of the images displayed on the display device 70 is determined on the basis of the panning mode signal 60, the orientation determination signal 61, the movement vector signal 62, etc., recorded to the removable memory 51.

Consequently, with this display control device 82, the direction of movement of the subject or the movement of the digital camera 1 can be made to coincide substantially with the layout of the images, and this reduces any unnaturalness in the displayed images.

Also, an example of using a display device equipped with the removable memory insertion unit 81 was given, but the present invention is not limited to this. For example, a reading device such as a memory card reader capable of reading the removable memory 51 may be connected with a display device.

### Other Embodiments

The specific constitution of the present invention is not limited to the embodiments given above, and various changes and modifications are possible without departing from the gist of the invention.

(1)

With the above embodiments, the digital camera 1 was used to describe a display control device, but the device in which the display control device is installed is not limited to a digital camera, and as long as it is a device with which images captured with a digital camera can be displayed, the installation can be in some other device (such as a digital single lens reflex camera, a digital video camera, a mobile telephone terminal with a camera function, a PDA (personal digital assistant) with a camera function, a PC (person computer) with a camera function, a DVD (digital video disk) recorder, or a hard disk recorder).

The imaging device can be a device capable of capturing moving pictures, or a device capable of capturing moving pictures and still pictures. Examples of imaging devices besides the above-mentioned digital camera 1 include digital single lens reflex camera, digital video cameras, mobile telephone terminals with a camera function, PDA's (personal digital assistants) with a camera function, and PC's (person computer) with a camera function.

(2)

In the first embodiment above, the layout of the images was determined by dividing nine types of panning mode signal 60 (“0” to “8”) substantially into two groups (to the left, and other). However, when the display unit 55 or other such display unit is capable of display in a state in which a plurality of images are laid out diagonally or above one another, the types may be further broken down into smaller groups. By breaking the panning mode signals 60 down into smaller groups, the panning direction or the direction in which the subject is moving can be made to coincide substantially with the movement direction of images in a slideshow, which reduces any unnaturalness in the displayed images.

(3)

In the first embodiment, angular velocity signals from the angular velocity sensors 17x and 17y were utilized to detect the panning mode, but signals from the yaw current value detector 14x and the pitch current value detector 14y may be utilized instead of the angular velocity sensors 17x and 17y.

Also, in the first embodiment, the imaging orientation was determined by detecting the current values of the pitch current value detector 14y and the yaw current value detector 14x, but it is also possible to find the imaging orientation by detecting the current value of just one or the other.

Also, if an abnormality occurs in either the pitch current value detector 14y or the yaw current value detector 14x, the imaging orientation can be accurately determined by detecting the current values of both detectors.

Furthermore, in the first embodiment, the imaging orientation was determined by detecting the current value of pitch and yaw current detectors, but the invention is not limited to this. For instance, the same effect can be obtained by measuring the voltage value.

(4)

In the first and second embodiments, the description was of an example of using a blur correction device for detecting the orientation and the panning mode, but instead, for example, an angular velocity sensor, acceleration sensor, rotational angle detection device, or the like may be attached to the main body of the digital camera 1. Also, for subject movement detection, a special movement detection sensor may be provided to the digital camera 1 besides the movement vector detection performed using images.

Also, in the above embodiments, a single shutter button was provided to the digital camera 1, but instead, for example, a shutter button for imaging in landscape orientation and a shutter button for imaging in portrait orientation may each be provided. In this case, the imaging orientation can be ascertained on the basis of signals from the two shutter buttons.

(5)

In the first and second embodiments, portrait orientation was considered to be one in which the orientation was rotated 90° to the right around the optical axis AX, using the case of landscape orientation as a reference, but the same effect as above can be obtained when portrait orientation is one in which the orientation is rotated 90° to the left. In this case, the orientation determination signal 61 for an orientation rotated 90° to the left is “2,” and a total of three kinds of orientation can be detected: one kind of landscape orientation and two kinds of portrait orientation.

(6)

In the first and second embodiments, two kinds of signal, in which the orientation determination signal 61 was “0” or “1,” were added to the images, but instead, for example, a signal can be added for just one orientation (such as portrait orientation). Nor is the invention limited to recording the orientation determination signal 61 to an image, and a method may be employed in which the orientation determination signal 61 and the image are recorded to separate files, and the image is associated with the file to which the orientation determination signal 61 is recorded. Similarly, the panning mode signal 60 and the movement vector signal 62 may also be recorded to files separate from the image file, and these files associated with the image.

(7)

The embodiments given above can also be combined. For example, the first embodiment and the second embodiment can be combined. More specifically, in the first embodiment, when the vertical and horizontal components of panning are both “none,” that is, when the panning mode signal 60 is “0,” the digital camera 1 is being held steady. Therefore, it is also conceivable in this case that the movement vector signal 62 is produced from the image, and the layout of the images is determined on the basis of the movement vector signal 62 as in the second embodiment. If the panning mode signal 60 is something other than “0,” it is conceivable that the panning mode signal 60 will be given priority.

(8)

In the first and second embodiments, a case was described in which a plurality of images were displayed as a slideshow, but there do not have to be a plurality of images in the slideshow, and slideshow display is possible even with a single image.

(9)

In the first and second embodiments, only a slide-in/slide-out display was described as the display mode in the slideshow display based on first movement information, second movement information, and orientation information, but other display modes are also possible, such as zoom-in/zoom-out or fade-in/fade-out, based on the above-mentioned information. More specifically, for images captured using the movement vector signal 62 as the second movement information, and especially when the subject is approaching the user, zoom-in display is a visually effective way to display a slideshow.

Also, it is even more effective if the speed at which the images are displayed in a slideshow is matched to the to the movement speed of the subject or to the panning speed. In other words, a display method may be employed wherein if the speed is high, then the display speed from slide-in until slide-out is reduced, but if the speed is low, the display speed from slide-in until slide-out is raised.

The slideshow display methods shown in FIGS. 20A to 23C involved having one image slide in all the way, and the having another image slide in, but another possible display method involves displaying two images at the same time, that is, having the next image slide in before the previous image has slid out completely.

Also, the camera described above can be realized by a program that functions as the imaging control method for the camera. This program is stored on a recording medium that can be read by a computer.

(10)

It is also conceivable that the above-mentioned display method will be used for a slideshow display with a plurality of images arranged next to each other. Here, we will let V be the time vector with respect to the plurality of images. “Time vector” means the vector that extends from the center of a previously acquired image to the center of a subsequently acquired image when two images acquired at different times are displayed in order.

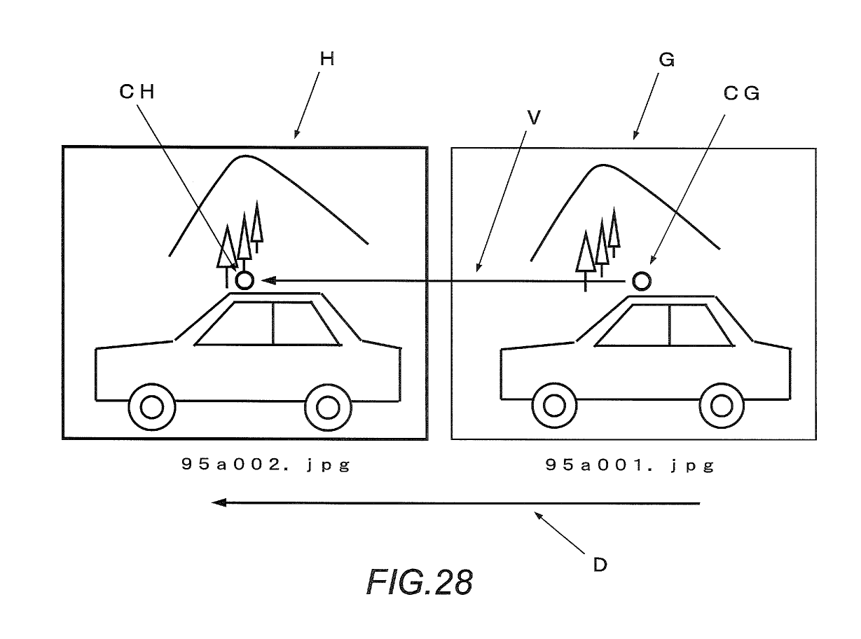

For example, as shown in FIG. 28, when a first image G acquired previously and a second image H acquired later than the first image G are arranged next to each other, an arrow extending from the center CG of the first image G to the center CH of the second image H expresses the time vector V. Thus, the time vector V expresses the flow of time as a direction when images acquired at different times are arranged next to each other.

As shown in FIG. 24, the first image G and the second image H are images of an automobile moving to the left, which were sequentially captured while panning to the left. Accordingly, the horizontal component of the direction of panning is the panning direction D (to the left).

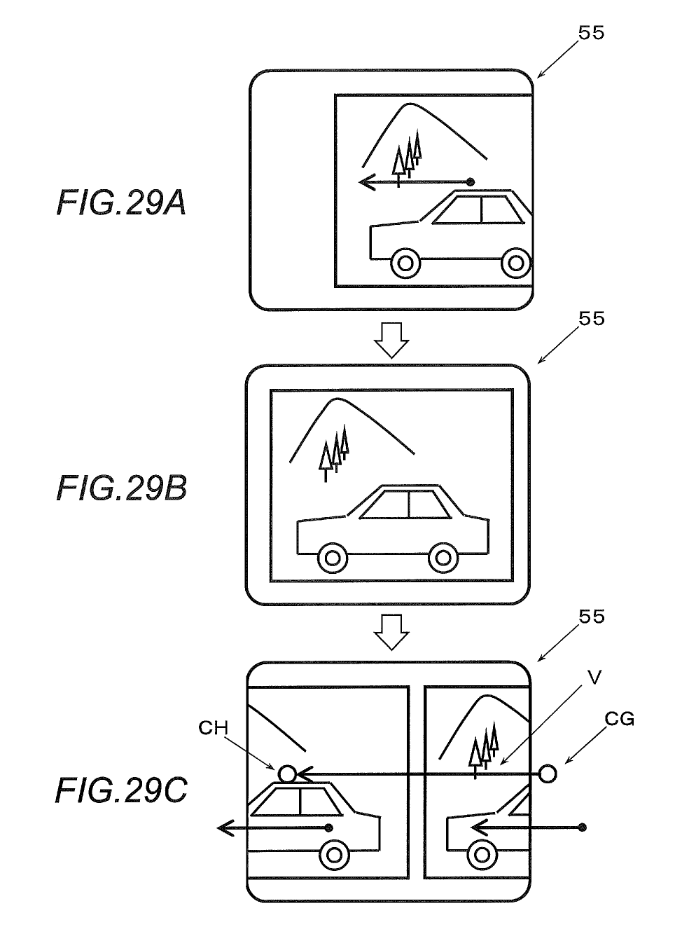

In this case, as shown in FIG. 29, if the first image G and the second image H are displayed in order so that the time vector V substantially coincides with the panning direction D, then the first image G and the second image H will look more natural to the user than when the panning direction and the time vector do not coincide (such as when they are opposite directions).

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including,” “having,” and their derivatives. Also, the terms “part,” “section,” “portion,” “member,” or “element” when used in the singular can have the dual meaning of a single part or a plurality of parts.

Moreover, the term “configured” as used herein to describe a component, section, or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A display control device for displaying on a display unit an image recorded to a recording part, comprising:
an acquisition section configured to acquire from the recording part an image and movement information related to at least one of the movement of a housing and the movement of a subject within the image;
a display method determination section configured to determine the display method of the image on the display unit on the basis of the movement information; and
an image display controller configured to display the image on the display unit so that the image moves on the screen of the display unit, on the basis of the determination result of the display method determination section.

2. The display control device according to claim 1, wherein
the display method determination section is configured to determine the movement direction of the image on the display unit such that the movement direction coincides with one component of the direction of movement indicated by the movement information, and
the image display controller is configured to control the display unit so that the image moves on the screen of the display unit in the determined movement direction.

3. An imaging device, comprising:
a housing;
an optical system supported by the housing and configured to form an optical image of a subject;
an image acquisition section configured to convert the optical image formed by the optical system into an electrical image signal, and configured to acquire an image of the subject;
a display unit configured to display images acquired by the image acquisition section;
a movement detector configured to acquire movement information relate to at least one of the movement of the imaging device and the movement of the subject within the image;
a display method determination section configured to determine the display method of the image on the display unit on the basis of the movement information; and
an image display controller configured to display the image on the display unit so that the image moves on the screen of the display unit, on the basis of the determination result of the display method determination section.

4. The imaging device according to claim 3, wherein
the display method determination section is configured to determine the movement direction such that the movement direction of the image on the display unit coincides with one component of the direction of movement indicated by the movement information, and
the image display controller is configured to control the display unit so that the image moves on the screen of the display unit in the determined movement direction.

5. The imaging device according to claim 4, wherein
the movement detector has a first movement detector configured to acquire first movement information related to the movement of the housing, and
the first movement detector has a first detector configured to detect the rotation of the housing with respect to a first axis, a second detector configured to detect the rotation of the housing with respect to a second axis that is perpendicular to the first axis, and a first information generator configured to generate the first movement information on the basis of the detection results of the first and second detectors.

6. The imaging device according to claim 5, wherein
the movement detector has a second movement detector configured to acquire second movement information related to the movement of the subject between a plurality of images, and
the second movement detector has a movement vector detector configured to detect the movement detector of the image, and a second information generator configured to generate the second movement information on the basis of the detection result of the movement vector detector.

7. The imaging device according to claim 6, further comprising:
an orientation detector configured to acquire orientation information related to the orientation of the imaging device, wherein
the orientation information from when the image is acquired is recorded along with the image to the recording part, and
the image display controller is configured to adjust the display state of the image with respect to the display unit so that the height direction in the image substantially coincides with the vertical direction in a state in which the image is displayed on the display unit, on the basis of the orientation information.

8. The imaging device according to claim 3, wherein
the movement detector has a first detector is configured to acquire first movement information related to the movement of the housing, and
the first movement detector has a first detector is configured to detect the rotation of the housing with respect to a first axis, a second detector configured to detect the rotation of the housing with respect to a second axis that is perpendicular to the first axis, and a first information generator configured to generate the first movement information on the basis of the detection results of the first and second detectors.

9. The imaging device according to claim 8, wherein
the movement detector has a second movement detector configured to acquire second movement information related to the movement of the subject between a plurality of images, and
the second movement detector has a movement vector detector configured to detect the movement detector of the image, and a second information generator configured to generate the second movement information on the basis of the detection result of the movement vector detector.

10. The imaging device according to claim 9, further comprising:
an orientation detector configured to acquire orientation information related to the orientation of the imaging device, wherein
the orientation information from when the image is acquired is recorded along with the image to the recording part, and
the image display controller is configured to adjust the display state of the image with respect to the display unit so that the height direction in the image substantially coincides with the vertical direction in a state in which the image is displayed on the display unit, on the basis of the orientation information.

11. The imaging device according to claim 3, wherein
the movement detector has a second movement detector is configured to acquire second movement information related to the movement of the subject between a plurality of images, and
the second movement detector has a movement vector detector configured to detect the movement detector of the image, and a second information generator configured to generate the second movement information on the basis of the detection result of the movement vector detector.

12. The imaging device according to claim 11, further comprising:
an orientation detector configured to acquire orientation information related to the orientation of the imaging device, wherein
the orientation information from when the image is acquired is recorded along with the image to the recording part, and
the image display controller is configured to adjust the display state of the image with respect to the display unit so that the height direction in the image substantially coincides with the vertical direction in a state in which the image is displayed on the display unit, on the basis of the orientation information.

13. The imaging device according to claim 3, further comprising:
an orientation detector configured to acquire orientation information related to the orientation of the imaging device, wherein
the orientation information from when the image is acquired is recorded along with the image to the recording part, and
the image display controller is configured to adjust the display state of the image with respect to the display unit so that the height direction in the image substantially coincides with the vertical direction in a state in which the image is displayed on the display unit, on the basis of the orientation information.
